(19) United States
(12) Patent Application Publication
(10) Pub. No.: US 2022/0162887 A1
(43) Pub. Date: May 26, 2022

(54) DOUBLE PULL LATCHING SYSTEM FOR FRONT TRUNK OF A MOTOR VEHICLE

(71) Applicant: Magna BÖCO GmbH, Wuppertal (DE)

(72) Inventors: Stefan Page, Wuppertal (DE); Bernardo Enrices, Wuppertal (DE)

(21) Appl. No.: 17/532,136

(22) Filed: Nov. 22, 2021

Related U.S. Application Data
(60) Provisional application No. 63/139,887, filed on Jan. 21, 2021.
(60) Provisional application No. 63/117,239, filed on Nov. 23, 2020.

(51) Int. Cl. E05B 77/54; E05B 79/20; E05B 83/18; E05B 83/24; E05B 85/24

(52) U.S. Cl. CPC E05B 77/54; E05B 79/20; E05B 85/243; E05B 83/243; E05B 83/18

(57) ABSTRACT

A latch system includes a double pull latch, where a fully open state is achieved following two release actuations. A coupling assembly is disposed on an actuation cable between a release mechanism and the latch. The coupling assembly is in the form of a switch that blocks or allows a pull on the actuation cable to pass to the latch depending on a predetermined condition of the vehicle. The switch may include a connecting lever that is moveable into and out of coupling engagement between first and second portions of the actuation cable. The connecting lever may de-couple the cable portions only after a first actuation is complete, thereby allowing a partial opening of the trunk but preventing a fully opening if the predetermined condition is satisfied, such as exceeded a threshold vehicle speed.

### CROSS-REFERENCE TO RELATED APPLICATIONS

This application is claims the benefit of previously filed U.S. Provisional Application Ser. No. 63/117,239, filed Nov. 23, 2020, and previously filed U.S. Provisional Application Ser. No. 63/139,887, filed Jan. 21, 2021, both of which are incorporated herein by reference in their entirety. This application is related to previously filed U.S. patent application Ser. No. 16/403,141, filed May 3, 2019, which is incorporated herein by reference in its entirety.

### FIELD

The present disclosure relates to latch assemblies for motor vehicles, and more particularly, to trunk latch assemblies for motor vehicles.

### BACKGROUND

Latches for vehicle front hoods, whether for front engine hoods or front trunk hoods also known as frunks, are typically actuated in two stages. During a first stage a first release device, such as a handle, is actuated from inside the passenger compartment of the vehicle which moves the latch from a primary closed position to secondary closed position, wherein the latch is partially released, but still retains a striker of the hood to keep the hood from being fully opened. To release the latch completely the vehicle occupant typically must exit the vehicle and actuate a second release device, such as a lever, that is under the hood. This may be inconvenient in some situations.

Double-pull release latches for vehicle hoods are also known, which allows a user to pull twice on the hood release handle located inside the passenger compartment of the vehicle to cause the latch to both transition from the primary closed position to the secondary closed position upon the first pull, and then to fully release the latch from the secondary closed position to a fully open position upon the second pull. One drawback of such a double-pull release latch for a vehicle hood is that the user may unintentionally release the hood, which can be particularly problematic if the hood is a front hood that is caused to open while the vehicle is moving. Further yet, if the hood is for a front trunk compartment, the double pull latch is typically only actuatable from inside the passenger compartment, and thus, if a person were to become locked and entrapped inside the front trunk compartment, the entrapped person would be unable to open the front hood.

Desired is a latch which can be unlatched in a multiple stage release actuations from inside of the passenger compartment of the vehicle when intended, such as while the vehicle is not moving or moving slowly (below a predetermined threshold speed), and wherein the latch is prevented from being fully released to an open position while the vehicle is traveling in excess of the predetermined speed and/or while the engine is running and/or other vehicle state. Further, it is desired to integrate an auxiliary mechanism into the multiple stage release hood latch that allows a person to release the latch from within a stowage compartment, including the front trunk compartment. It is further desired to configure the auxiliary latch mechanism to allow the latch to be fully released while the vehicle is not moving or traveling below a predetermined speed and/or while the engine is not on and/or other vehicle state, and to allow the latch to move from the primary closed position to the secondary closed position when the vehicle is moving in excess of the predetermined speed and/or while the engine is on and/or other vehicle state, but not to the fully open position.

### SUMMARY

This section provides a general summary of the present disclosure and is not a comprehensive disclosure of its full scope or all of its features, aspects and objectives.

In accordance with another aspect of the disclosure, a latch assembly for a stowage compartment of a motor vehicle is provided, wherein the latch assembly can be opened from within the stowage compartment.

In accordance with another aspect of the disclosure, a latch assembly for a front trunk hood, or frunk, is provided, wherein the latch assembly can be opened from within a compartment of the front trunk.

In accordance with another aspect of the disclosure, the latch assembly can be actuated to partially open the front trunk hood, but prevent the front trunk hood from moving to a fully opened position if a predetermined condition is met, such as and engine on/off condition or a vehicle speed condition, for example.

In accordance with another aspect of the disclosure, the latch assembly can be opened from within a passenger compartment of the motor vehicle, and preferably perform as a multiple pull latch assembly, and more preferably a double pull latch assembly, whereupon a first pull acts to move the latch to a secondary, partially open position, and whereupon a second pull acts to move the latch to a fully open position.

In accordance with another aspect of the disclosure, the latch assembly may be configured to operate in a normal mode to allow the latch assembly to be opened from the trunk, and for example a frunk, compartment of the motor vehicle of the motor vehicle if a predetermined condition of the vehicle is not met, and may be configured to operate in a safety mode to allow the latch assembly to be opened to a secondary closed position from within the trunk, and for example a frunk, compartment of the motor vehicle of the motor vehicle, but not to a fully opened condition if a predetermined condition of the vehicle is met.

According to an aspect, a latching system for a hood of a trunk of a vehicle is provided, the system comprising: a latch; a release mechanism configured to be accessible within the trunk or the cabin of the vehicle for actuating the latch; a coupling assembly positioned between the latch and the release mechanism; wherein actuation of the release mechanism when the coupling assembly is in a normal mode causes the latch to release; wherein actuation of the release mechanism when the coupling assembly is in a safety mode prevents the latch from releasing.

In one aspect, the latch is a double-pull latch, wherein a first pull applied to the latch moves the latch from a primary latched state to a secondary latched state, and a second pull applied to the latch moves the latch from the secondary latched state to a fully open state, and the coupling assembly is a switch configured to selectively prevent a second pull from being applied to the latch.

In one aspect, the switch prevents a second pull from being applied to the latch in response to a predetermined condition of the vehicle being satisfied.

In one aspect, the predetermined condition is a threshold speed being exceeded.

In one aspect, the switch blocks an actuation cable from being pulled.

In one aspect, the switch is disposed between a first portion of a cable and a second portion of a cable, wherein the switch disengages the first portion from the second portion.

In one aspect, the predetermined condition includes a first pull being completed and a threshold speed being exceeded.

In one aspect, the switch includes connecting lever pivotable between an engaged position coupling a first cable portion and a second cable portion, and a disengaged position in which the first cable portion and the second cable portion are de-coupled.

In one aspect, the connecting lever moves from the engaged positon to the disengaged position in response to engagement by a cam.

In one aspect, the connecting lever moves from the engaged position to the disengaged position in response to engagement by a cam and following a first pull when in the engaged position.

In one aspect, the cam is disengaged from the connecting lever by a gear output lever, wherein movement of the gear output permits movement of the cam toward the connecting lever to an intermediate position, and wherein the cam moves into position to engage and move the connecting lever after the connecting lever has been pulled a first time when the cam is in the intermediate position.

In one aspect, the switch includes a slider attached to a first cable portion and a slider housing attached to a second cable portion, wherein the switch is actuatable between an engaged state coupling the slider to the slider housing and a disengaged state in which the slider is de-coupled from the slider housing, wherein translation of the slider in the engaged state translates the slider housing, and translation of the slider is in the disengaged state does not translate the slider housing.

In one aspect, the switch includes a connecting lever pivotally attached to the slider housing, wherein the connecting lever is selectively moveable into and out of engagement with the slider.

In one aspect, a cam is actuatable into engagement with the connecting lever to actuate the connecting lever out of engagement with the slider.

In one aspect, the cam actuates the connecting lever only after the slider has been pulled a first time.

In one aspect, the cam is actuated into an intermediate position in response to actuation by a gear output lever.

In one aspect, the cam is biased toward engagement with the connecting lever, and the gear output lever is actuated to pivot away from the cam and allows the cam to move toward engagement with the connecting lever.

In one aspect, a force vector applied by the cam on the gear output lever prior to actuation by the gear output lever is eccentric relative to pivot axes of the cam and the gear output lever.

In one aspect, a first cable extends from a manual release lever and a second cable extends from an electric cable actuator, wherein the first cable is attached to the slider, and the second cable extends through the slider, wherein the slider housing is coupled to a safety hook of the latch, and the second cable is attached to a pawl of the latch.

In one aspect, actuation of the first cable pulls the slider, and the slider pulls the second cable, and wherein actuation of the second cable independent of the first cable does not pull the slider, and actuation of the second cable occurs in response to a pull on the first cable in both the engaged and disengaged state of the connecting lever.

In one aspect, the slider includes an outwardly extending flange, and the second cable includes a ferrule fixed thereto, wherein the flange applies a force on the ferrule in response to a pulling force applied to the slider.

In another aspect, a method of operating a latch for a trunk or a hood of a vehicle is provided, such as for the latch systems described above, the method including: detecting a condition that satisfies a predetermined condition of the vehicle; in response to detecting the predetermined condition, actuating a switch from a normal mode to a safety mode; wherein the switch is positioned between a latch and a release mechanism, wherein the release mechanism is accessible within the trunk or the cabin of the vehicle and configured for actuating the latch; wherein actuation of the release mechanism when the coupling assembly is in a normal mode causes the latch to release; wherein actuation of the release mechanism when the coupling assembly is in a safety mode prevents the latch from releasing; permitting a first actuation of the latch via the switch when the switch is in the normal mode or the safety mode; preventing a second actuation of the latch via the switch when the switch is in the safety mode; and permitting the second actuation of the latch via the switch when the switch is in the normal mode.

In another aspect, there is provided a method of controlling a coupling assembly for a latch, including the step of ascertaining the state of a vehicle, ascertaining a first activation of the latch, controlling a state of a coupling assembly positioned between the latch and the release mechanism of operatively coupling/decoupling the latch with the release mechanism in response to actuation of the release mechanism occurring for the first time and based on the state of a vehicle, controlling the state of the coupling assembly in the normal mode to configure the coupling assembly to facilitate transfer of a second pull of the handle release mechanism to allow the latch to be fully opened; and controlling the state of the coupling assembly in the safety mode to configure the coupling assembly to inhibit the transfer of the second pull of a handle release mechanism to the latch to prevent the latch from being fully opened.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1A is a front perspective view of a vehicle including a double pull latch system for a frunk in accordance with the disclosure;

FIGS. 2A and 2B are opposite side views of a double pull latch assembly shown in a fully latched position and constructed according to the present disclosure;

FIGS. 3A and 3B are views similar to FIGS. 2A and 2B with the double pull latch assembly shown during a first actuation of a primary pawl;

FIGS. 4A and 4B are views similar to FIGS. 3A and 3B with the double pull latch assembly shown after completion of the first actuation;

FIGS. 5A and 5B are views similar to FIGS. 4A and 4B with the double pull latch assembly shown during a second actuation of a primary pawl;

FIGS. 6A and 6B are views similar to FIGS. 3A and 3B with the double pull latch assembly shown after completion of the second actuation and in a fully open position;

FIGS. 7A and 7B are views similar to FIGS. 2A and 2B with the double pull latch assembly shown during an actuation of an auxiliary release lever via an auxiliary release member within the trunk;

FIGS. 8A and 8B are views similar to FIGS. 7A and 7B with the double pull latch assembly shown after completion of the actuation of the auxiliary release lever and in a fully open position;

FIGS. 9A and 9B are views similar to FIGS. 2A and 2B with the double pull latch assembly shown while the vehicle is in a predetermined condition causing an actuator to move a coupling lever to a disengaged position;

FIGS. 10A and 10B are views similar to FIGS. 9A and 9B with the double pull latch assembly shown during a first actuation of primary pawl with the coupling lever moved to the disengaged position;

FIGS. 11A and 11B are views similar to FIGS. 10A and 10B with the double pull latch assembly shown after completion of the first actuation of the primary pawl and with a ratchet in the second closed position;

FIGS. 12A and 12B are views similar to FIGS. 11A and 11B illustrating how a second actuation of the primary pawl does not cause the release of a secondary pawl due to the coupling lever being moved to the disengaged position;

FIGS. 13A and 13B are views similar to FIGS. 9A and 9B;

FIGS. 14A and 14B are views similar to FIGS. 13A and 13B with the double pull latch assembly shown during actuation of an auxiliary release lever via an auxiliary release member within the trunk;

FIGS. 15A and 15B are views similar to FIGS. 14A and 14B with the double pull latch assembly shown after completion of the actuation of the auxiliary release lever with the ratchet in the second closed position;

FIG. 16 is a schematic view of coupling assembly in the form of a switch disposed on an actuation cable that extends between a release mechanism and a double pull latch, where the switch is configured to block or allow a pull on the latch;

FIGS. 17A-E are schematic views of different embodiments of the switch that blocks actuation of the cable or decouples first and second portions of the cable from each other;

FIG. 18 is a schematic view of the latch system showing a manual release mechanism within a frunk and the cabin with actuation cables from each connected to the switch

FIG. 19 is a schematic view of the latch system showing a manual release mechanism within a frunk and a release actuator operable in response to a release signal, with actuation cables from each connected to the switch;

FIGS. 20A-D illustrates various views of a motor and actuator for actuating the switch;

FIGS. 21A-D illustrates top and side views of the switch illustrating an engaged state of a connecting lever and a cam device in a disengaged position relative to the connecting lever;

FIG. 22A illustrates a top, side, and an end view of the cam device and the connecting lever with the cam in the disengaged position;

FIG. 22B illustrates a top, side, and an end view of the cam device and the connecting lever engaging and actuating the connecting lever from the engaged state to the disengaged state in response to exceeding a threshold vehicle speed;

FIGS. 23A-B illustrates another aspect of the switch having a gear output lever controlling actuation of the cam device, and a connecting lever that is not actuatable to the disengaged position until after a first pull has been completed;

FIGS. 24A-B illustrate the connecting lever after actuation of the cam device and before a first pull;

FIGS. 25A-B illustrate the connecting device during the first pull;

FIGS. 26A-B illustrate the connecting device after returning from the first pull of FIGS. 25A-B, with the connecting lever being disengaged from the cable;

FIG. 27A-B are schematic views illustrating two variants of a latch system having a switch between release mechanisms and double pull latches in accordance with aspects of the disclosure;

FIG. 28A-B illustrates one aspect of a switch with a connecting lever, showing a cam device in contact with a side surface of the connecting in response to exceeding a threshold speed and before a first pull, with the cable portions remaining coupled;

FIG. 29A illustrates the position of the cam device and gear output lever prior to the first pull and prior to the vehicle exceeding the threshold level;

FIG. 29B illustrates the position of the cam device and gear output lever prior to the first pull and after the vehicle exceeding the threshold level;

FIG. 30 illustrates a system according to an aspect of the disclosure having two cables extending from manual release actuators into a switch and single cable extending from the switch to the latch;

FIGS. 31A-B illustrate a switch having a slider attached to a first cable portion extending to a manual release actuator and a slider housing attached to a second cable portion extending to the latch, and a connecting lever attached to the slider housing and selectively engaged with the slider in response to actuation of a gear output lever and a cam, with the connecting lever in an engaged state prior to actuation of the gear output lever and a first pull;

FIGS. 32A-B illustrate an end of the connecting lever received in a recess of the slider and engaged with the slider;

FIGS. 33A-B illustrate the gear output lever actuated in response to a predetermined condition, the cam in an intermediate position, and the connecting lever remaining engaged with the slider prior to a first pull;

FIGS. 34A-B illustrate the slider during a first pull and the cam in position to engage the connecting lever;

FIGS. 35A-B illustrate the slider returned after the first pull and the cam engaging the connecting lever to pivot the connecting lever out of engagement with the slider;

FIGS. 36A-B illustrate the slider pulled a second time, but the slider housing remaining in place with the connecting lever out of engagement with the slider;

FIGS. 37A-C illustrate a housing of the switch;

FIG. 38 illustrates a latch system having two actuation cables that extend between the release mechanisms and the latch, each cable extending into and out of the switch;

FIGS. 39A-B illustrates a switch according to an aspect of the disclosure, with a first cable coupled and decoupled based on actuation of the connecting lever, and a second cable extending through the switch, wherein actuation of the first cable actuates the slider and the second cable regardless of the state of the connecting lever;

FIGS. 40A-B illustrate the connecting lever engaged with the slider;

FIGS. 41A-B illustrate the connecting lever disengaged with the slider in response to actuation by a gear output lever;

FIGS. 42A-D illustrate additional views of the dual cable switch;

FIG. 43 is an exploded view of the switch of FIGS. 31A-36B; and

FIG. 44 is a method of controlling a coupling assembly for a latch, in accordance with an illustrative example.

### DETAILED DESCRIPTION OF EXAMPLE EMBODIMENTS

In general, example embodiments of double pull latch assemblies constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

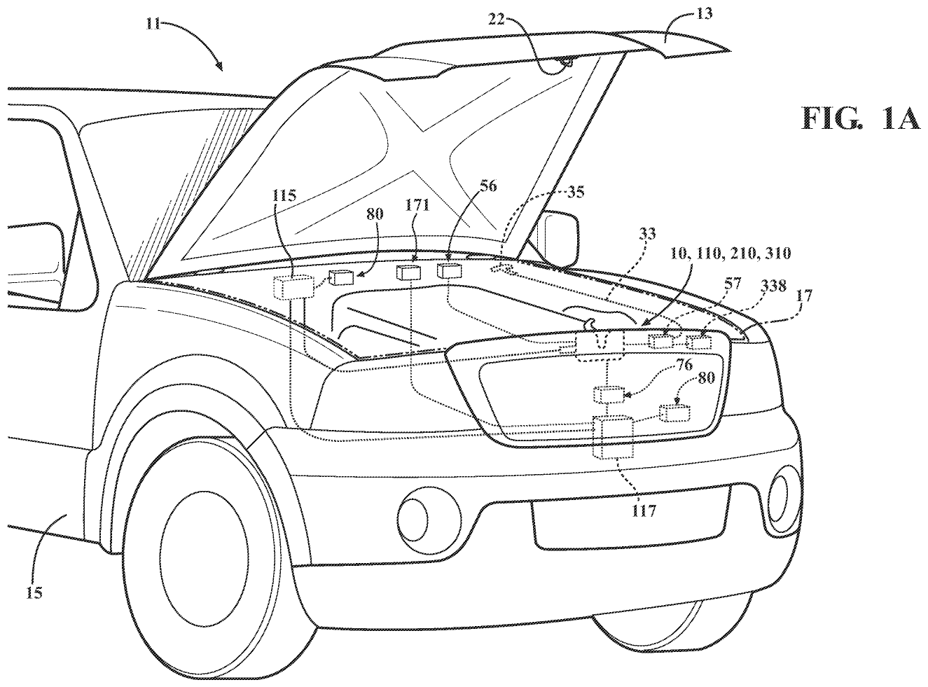

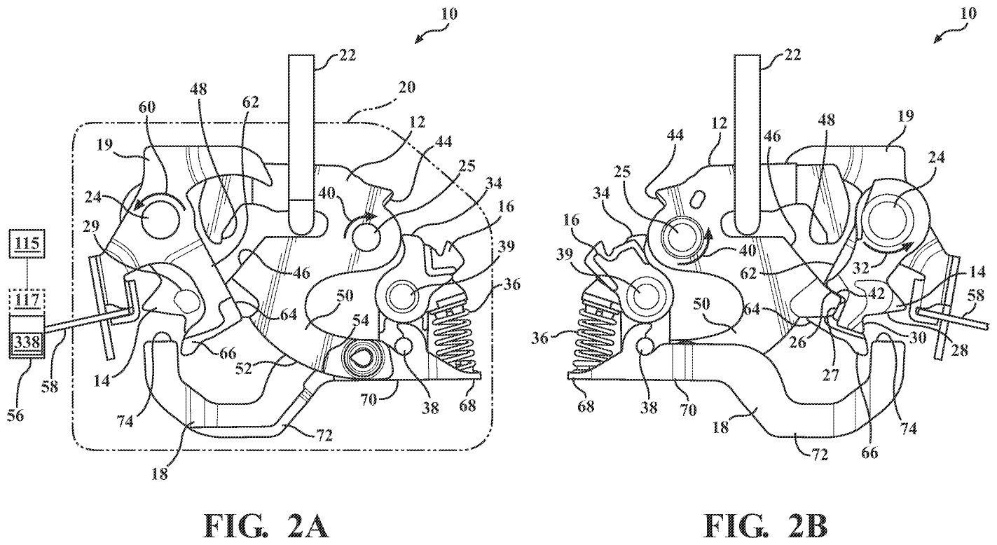

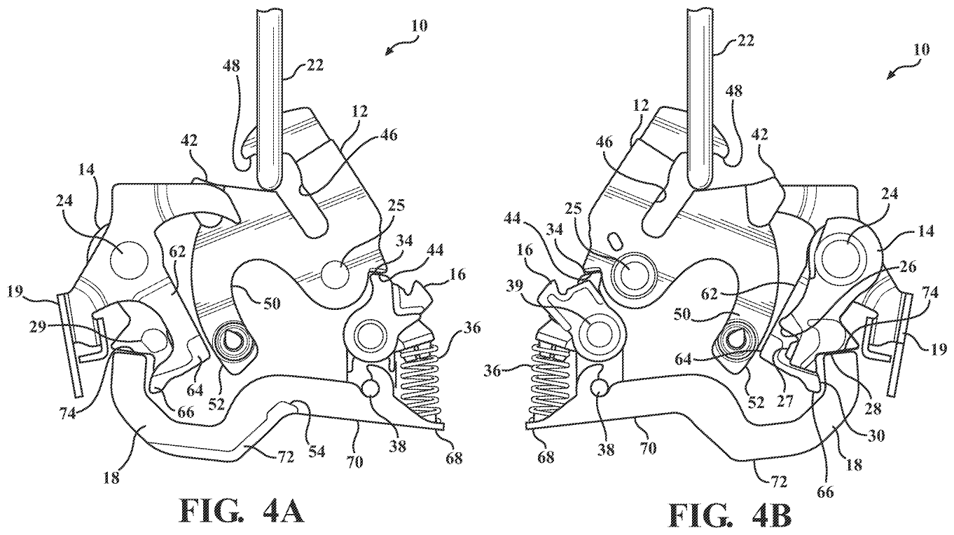

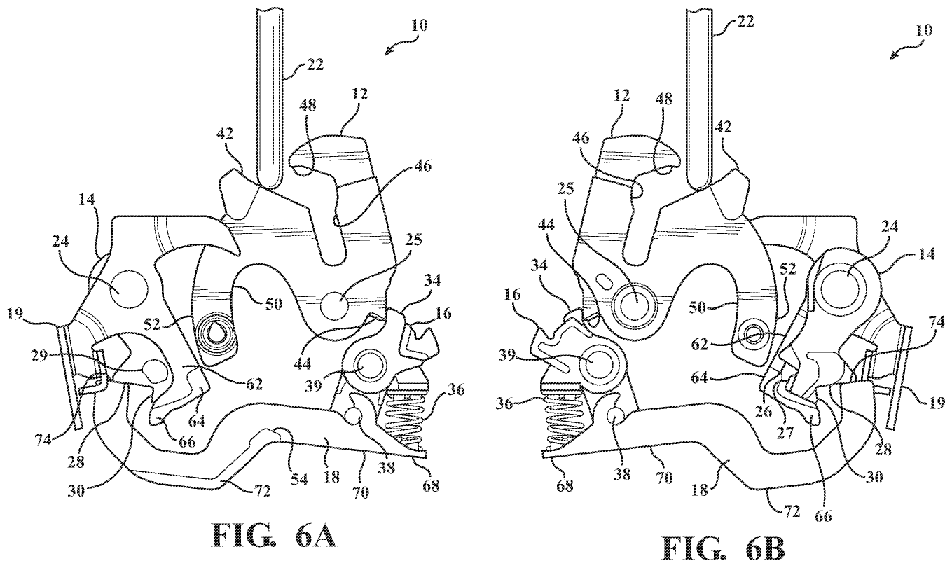

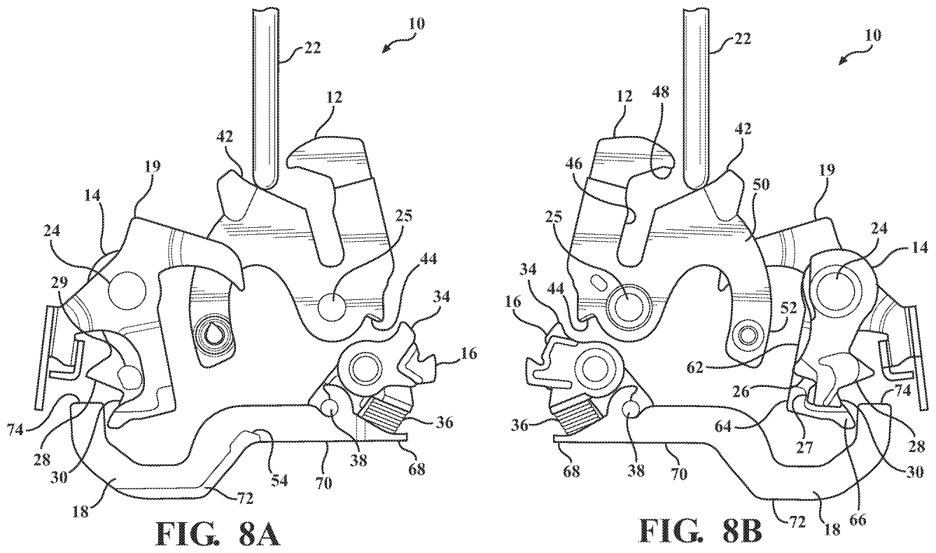

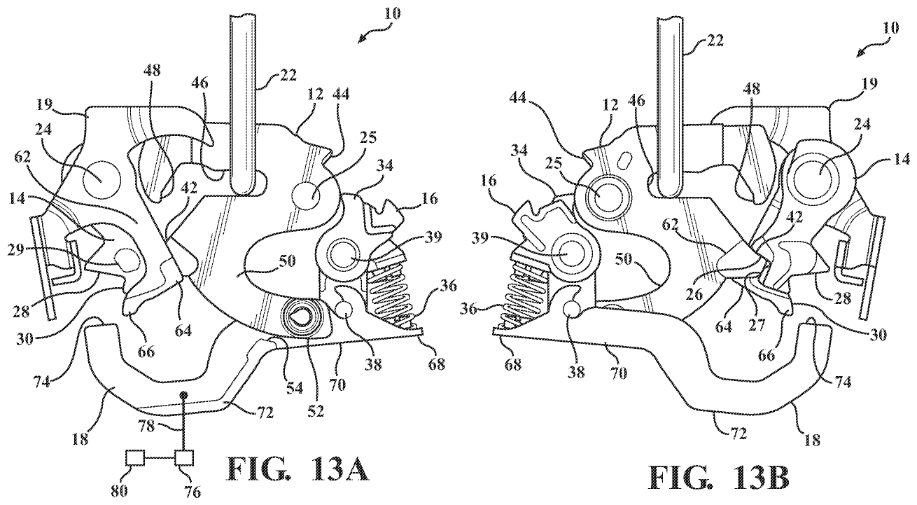

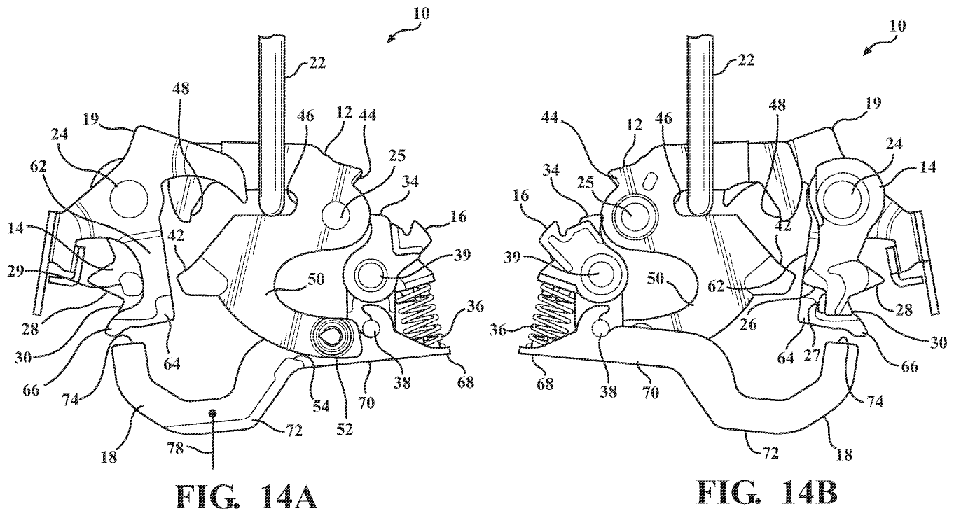

Reference is made to FIG. 1A, which shows a motor vehicle 11 that has a front hood 13, to which there is a striker 22 attached. Front hood 13 may enclose a front trunk 17, also referred to as frunk 17, for storage in a compartment provided in the front of the vehicle where an engine typically would occupy but has been provided at another location in the vehicle. The striker 22 is capturable by a double pull closure panel latch assembly, which can also be referred to as a double pull hood latch assembly if used in a vehicle hood application, and is generally referred to hereafter simply as latch assembly or latch 10, which is mounted on a body 15 of the motor vehicle 11. The front hood 13 can be opened to allow access to the stowage space, or frunk 17, with an engine of the vehicle being located elsewhere, such as in the rear of the vehicle, by way of example and without limitation. Referring to FIGS. 2A-15B, the latch 10 includes a ratchet 12, a pawl mechanism or pawl assembly having for example a primary pawl 14 and a secondary pawl 16, a coupling link, also referred to as coupling lever 18, an emergency release lever, also referred to as backup or auxiliary release lever 19, and a housing 20. Pawl assembly is illustratively shown mounted in the housing and operable in a primary locking state, a secondary locking state and an unlocking state, the pawl assembly configured in the primary locking state to hold the ratchet 12 in the primary closed position and in the secondary locking state to hold the ratchet 12 in a secondary closed position, and in the unlocking state to release the ratchet 12 from at least one of the primary closed position and secondary closed position. Illustratively pawl assembly is shown as having a primary pawl 14 and a secondary pawl 16 positioned each on opposite sides of the ratchet 12, but other configurations of the pawl assembly are possible to allow the pawl assembly to hold the ratchet in the primary closed position, the secondary closed position and to release the ratchet 12 from at least one of the primary closed position and secondary closed position. For example pawl assembly may be provided on one side of the ratchet 12, primary pawl 14 and a secondary pawl 16 may be integrated with one another, as but non-limiting examples. The ratchet 12 is pivotably connected to the housing 20 and is movable between a primary closed position or state (FIGS. 2A-3B, 7A, 7B, 9A-10B, 13A, 13B), a secondary closed position or state (FIGS. 4A-5B, 11A-12B, 15A, 15B) and an open position or state (FIGS. 6A, 6B, 8A, 8B) in response to selective movement of the pawl assembly, for example in response to selective movement of the primary and secondary pawls 14, 16, as discussed further hereafter. The pivotal movement of the ratchet 12 may take place about a pin 25 that can be mounted to the housing 20. In the primary and secondary closed positions, the ratchet 12 prevents the withdrawal of the striker 22 that is mounted to the vehicle hood 13 and/or some other closure panel having latch 10. When in the primary closed position, the ratchet 12 holds the striker 22 relatively deeper within a slot, commonly referred to fishmouth (not shown, but well-known in the art), of the housing 20, wherein the hood 13 is in a fully closed state, as compared to when ratchet 12 is in the secondary closed position, wherein the hood 13 is in a partially closed state, but prevented from being moved to the fully open position by ratchet 12. Thus, in the primary closed position the ratchet 12 holds the striker 22 at a first depth in the fishmouth, and in the secondary closed position the ratchet 12 holds the striker 22 at a second depth in the fishmouth of the housing 20, wherein the first depth is greater than the second depth.

A communication link, also referred to as release member, such as cable assembly and/or electrical member 33, that operably interconnects a pivotable primary pawl release lever (not shown, and referred to hereafter as release lever), that is configured in operable communication with primary pawl 14 of latch assembly 10, to an actuation device 35 located within a passenger compartment 37 of motor vehicle 11. The actuation device 35 is directly or indirectly, mechanically and/or electrically coupled for operable communication with the release lever, wherein the actuation device can be provided as a gearshift member, lever, moveable handle, depressible button, switch, rotatable knob, or otherwise.

The primary pawl 14 and auxiliary release lever 19 are shown being supported for respective pivotal movement about a pin 24. Primary pawl 14 has a primary locking surface 26, a first stop surface 27 extending outwardly from the primary locking surface, a second stop surface 28, a driven member 29, shown as a laterally outwardly extending lug or protrusion, and a drive surface 30 extending obliquely from drive surface 28. Primary pawl 14 is biased toward the primary locking position via any suitable biasing member, such as a spring member, shown schematically in FIG. 2B at arrow 32.

Secondary pawl 16 has a secondary locking surface 34 biased into abutment with ratchet 12 via any suitable biasing member, such as a spring member, shown as a coil spring 36, by way of example and without limitation. A pin 38 extends laterally outwardly from a generally planar surface of the secondary pawl 16, wherein pin 38 supports coupling lever 18 for pivotal movement thereon. Pivotal movement of the secondary pawl 16 may take place about a pin 39 that can be mounted to the housing 20. Coupling lever 18 is an illustrative example of a coupling or interconnecting mechanism between primary pawl 14 and secondary pawl 16 providing a relationship between the movement or change of state of the primary pawl 14 and the secondary pawl 16, for example such that a movement or change of state of primary pawl 14 may impart a corresponding or conjoint movement or change of state of secondary pawl 16 when primary pawl 14 and secondary pawl 16 are coupled together, or a movement or change of state of primary pawl 14 may not impart a corresponding or conjoint movement of secondary pawl 16 when primary pawl 14 and secondary pawl 16 are not coupled or interconnected together.

The ratchet 12 is biased toward the open position by a ratchet biasing member, such as via any suitable coil or torsion spring member, by way of example and without limitation, shown schematically by arrow 40 (FIG. 2A). Ratchet 12 has a primary locking surface 42 configured for selective releasably locked engagement with primary locking surface 26 of primary pawl 14 and a secondary locking surface 44 configured for selective releasably locked engagement with secondary locking surface 34 of secondary pawl 16. Ratchet 12 has a slot 46, shown as being generally V-shaped along its length, by way of example and without limitation, configured for receipt of striker 22 therein while in the primary and secondary closed positions, as is known. To facilitate maintaining the ratchet 12 in the secondary closed position, until desired to move ratchet 12 to the fully open position, a hook-shaped nose 48 is provided at an exit region of the slot 46. Ratchet 12 has an elongate, arcuate arm 50 extending away from slot 46 into generally underlying relation with pin 25. Arm 50 has a peripheral outer holding surface 52 contoured for selective abutment with a shoulder 54 of coupling lever 18 to selectively maintain coupling lever in a home position while latch 10 is fully latched with ratchet 12 in its primary closed position.

The auxiliary release lever 19 is configured for attachment to an auxiliary release member (shown schematically at 56 in FIG. 1) within the trunk 17 providing a release mechanism accessible from within the trunk 17 or frunk 17, such as via any suitable mechanically actuatable member 58, including a cable, such as a Bowden cable, or rod, by way of example and without limitation. The auxiliary release lever 19 is mounted to the housing 20 for pivoting movement between a released position and an actuated position in response to selective actuation of the auxiliary release member 56, wherein the auxiliary release lever 19 is biased toward the released position, such as via any suitable biasing member, including a spring member, shown in FIG. 2A schematically at 60. Auxiliary release lever 19 has an elongate drive arm 62 extending away from pin 24 for receipt between driven member 29 of primary pawl 14 and ratchet 12. While in the primary closed position, a generally L-shaped end region 64 of drive arm 62 is biased into abutment with ratchet 12 at a location from which arm 50 extends, with end region 64 also being in abutment with driven member 29. The L-shaped end region 64 has a leg 66 that extends generally about driven member 29 to facilitate capturing and selectively driving driven member 29.

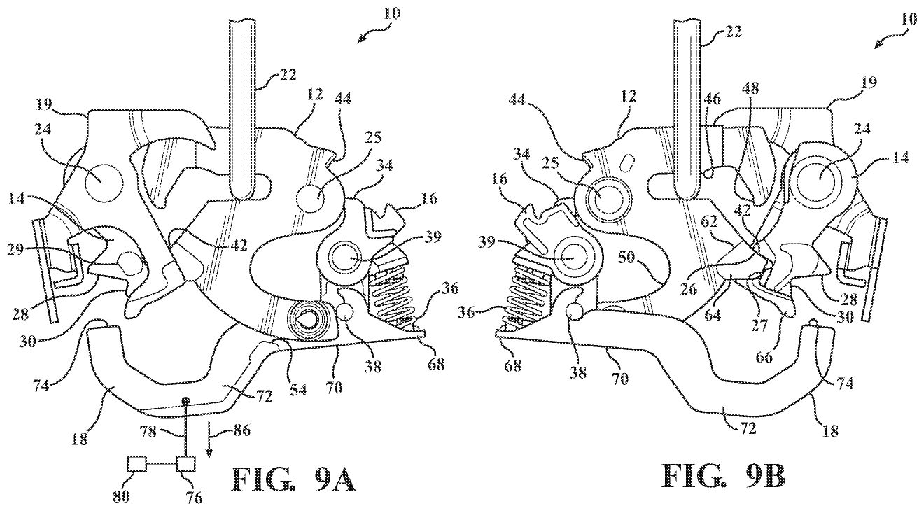

The coupling lever 18 is pivotably mounted to the secondary pawl 16 via pin 38 for movement between a connected position, also referred to as an engaged position or state (FIGS. 4A-6B), a disengaged position or state (FIGS. 9A-15B), and a home position or state (FIGS. 2A-3B, 7A-8B) between the engaged and disengaged positions. The coupling lever 18 is biased toward the engaged position by any suitable biasing member, and is shown as being biased by biasing member 36 in common with secondary pawl 16. Accordingly, biasing member 36 is forcibly compressed between secondary pawl 16 and a free end 68 of coupling lever 18 to cause secondary pawl 16 and coupling lever 18 to be pivoted away from one another about their respective pins 39, 38. Coupling lever 18 extends along a generally straight portion 70 from free end 68 to a generally C-shaped portion 72 that terminates at a free end 74. The C-shaped portion 72 opens toward latch 10 with free end 74, while in the home and engaged positions, wrapping beyond and into close proximity with leg 66 of auxiliary release lever 19.

As shown in FIG. 9A, an actuator 76 is operably coupled to the coupling lever 18, such as via a rod or cable 78, by way of example and without limitation. The actuator 76 may be an electric motor type actuator, or a solenoid type actuator for example and without limitation. The actuator 76 is configured for communication with a vehicle sensor 80, either directly or indirectly, to change the operating mode of the latch 10 by controlling the operation of the pawl assembly, and for example by controlling the interrelationship between the primary pawl 14 and the secondary pawl 16, by selectively moving the coupling lever 18 between the home position and the disengaged position in response to a predetermined state of the vehicle in accordance with an illustrative example. The actuator 76 may be indirectly in communication with vehicle sensor 80, for example actuator 76 may be in communication with a Body Control Module such as Body Control Module 115, or other vehicle controller, such as controller 117, which is in turn in communication with the vehicle sensor 80. It is to be recognized that the sensor 80 is configured to detect the desired predetermined state of the vehicle 11 whereupon movement of the coupling lever 18 from the home position to the disengaged position is desired, and vice versa. The sensor 80 may be in operable communication with the vehicle control/computer system, such as the Body Control Module 115, indicating the state of various vehicle operating parameters, such as throttle position, brake pedal position, key inserted, or key/on off positions, speed, engine operation, parking brake engaged, and the like, by way of example and without limitation. As another example, the sensor 80 may be in operable communication with multiple vehicle systems and capable of making a determination as to the motive operation of the motor vehicle 11. Accordingly, the sensor 80 can signal the actuator 76 to move the coupling lever 18 to the disengaged position upon recognition of the predetermined state of the vehicle. In one example, a predetermined state may be associated with the speed of the vehicle, such that upon the motor vehicle 11 reaching or exceeding the predetermined speed, the sensor 80 signals the actuator 76 to move the coupling lever 18 to the disengaged position, thereby prevent the latch 10 from being fully unlatched, as discussed in more detail below. In another example, a predetermined state may be associated with the state of an engine of the vehicle 11, such that if the engine is on, the sensor 80 signals the actuator 76 to move the coupling lever 18 to the disengaged position. It is to be recognized that the actuator 76 will return the coupling lever 18 to the home position upon the sensor 80 detecting the predetermined state no longer exists, such as the vehicle 11 slowing below a predetermined speed or the engine being turned off, by way of example and without limitation.

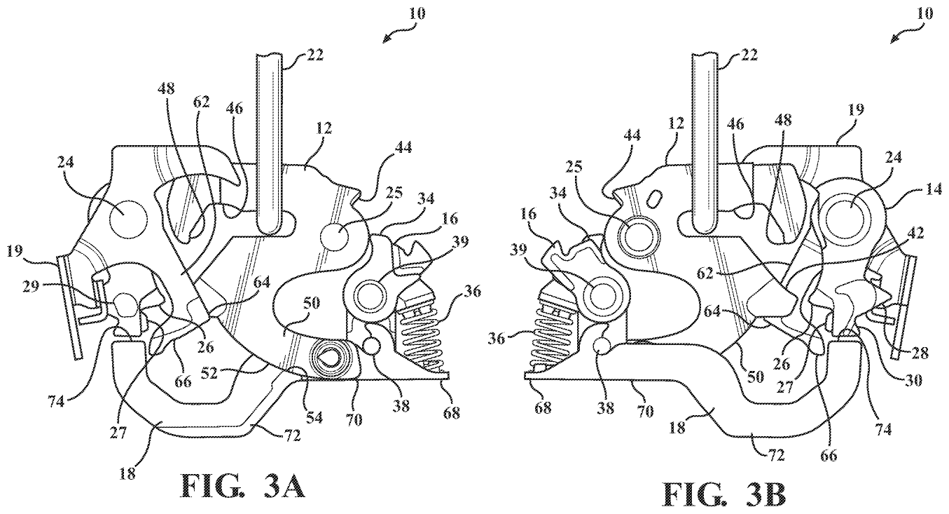

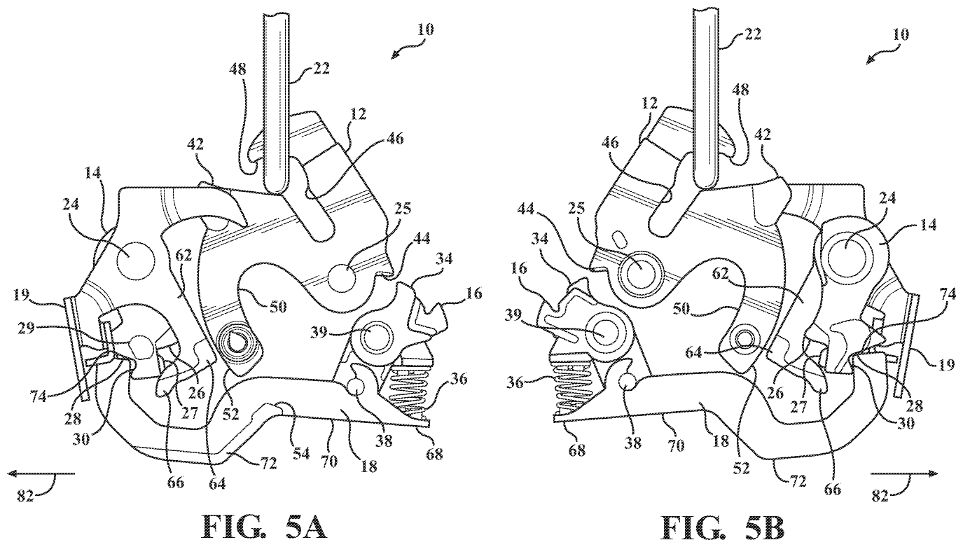

In use, in a normal release condition whereby the pawl assembly is operating in a normal mode, with the coupling lever 18 in the home position and the ratchet 12 in the primary closed position (FIGS. 2A, 2B), movement of the primary pawl 14 from the primary locking position to the primary unlocking position (FIGS. 3A-4B) in response to a first actuation of the release member (e.g. pawl release lever) causes the ratchet 12 to move from the primary closed position to the secondary closed position. During movement of the ratchet 12 to the secondary closed position, the holding surface 52 of ratchet 12 slides along shoulder 54 of coupling lever 18 and ultimately moves out of contact with shoulder 54, whereupon the coupling lever 18 is automatically biased by biasing member 36 to move from the home position to the engaged position. Upon the primary locking surface 26 of primary pawl 14 moving out from engagement from primary locking surface 42 of ratchet 12, the biasing member 40 biases ratchet 12 to the secondary closed position, whereat secondary locking surface 34 of secondary pawl 16 engages secondary locking surface 44 of ratchet 12 to releasably maintain the ratchet 12 in the secondary closed position. Upon performing a first actuation of primary pawl 14, primary pawl 14 is biased by biasing member 32 to return to its home primary locking position whereupon second stop surface 28 confronts and abuts free end 74 of coupling lever 18, thereby holding the coupling lever 18 in the engaged position (FIGS. 4A, 4B). Then, when desired to fully release latch 10, repeated actuation of the primary pawl 14 is performed, such as via a second actuation of actuation device 35 inside the passenger compartment 37, causing movement of the primary pawl 14 to the primary unlocking position in response to a second actuation of the release member, whereupon drive surface 30 of primary pawl 14 engages a region of the coupling lever 18 immediately adjacent free end 74 and moves the coupling lever 18 in translation generally along a direction indicated by arrow 82 (FIGS. 5A, 5B). With coupling lever 18 moved in the direction of arrow 82, the secondary pawl 16 is caused to pivot about pin 39 out from the secondary locking position to the secondary unlocking position, whereupon secondary locking surfaces 34, 44 move out of engagement from one another, whereupon ratchet 12 is caused to move under the bias of biasing member 40 from the secondary closed position to the open position (FIGS. 6A, 6B). At this time, hood 13 may be moved to a fully open position. The above is performed in normal course of use, for example when the latch 10 is operating in a normal mode, without a predetermined condition having been met, such as engine running or exceeding a predetermined speed, by way of example and without limitation, by actuation of the latch 10 from within the passenger compartment 37 via actuation device 35, such that the hood 13 may be moved safely to a fully open position.

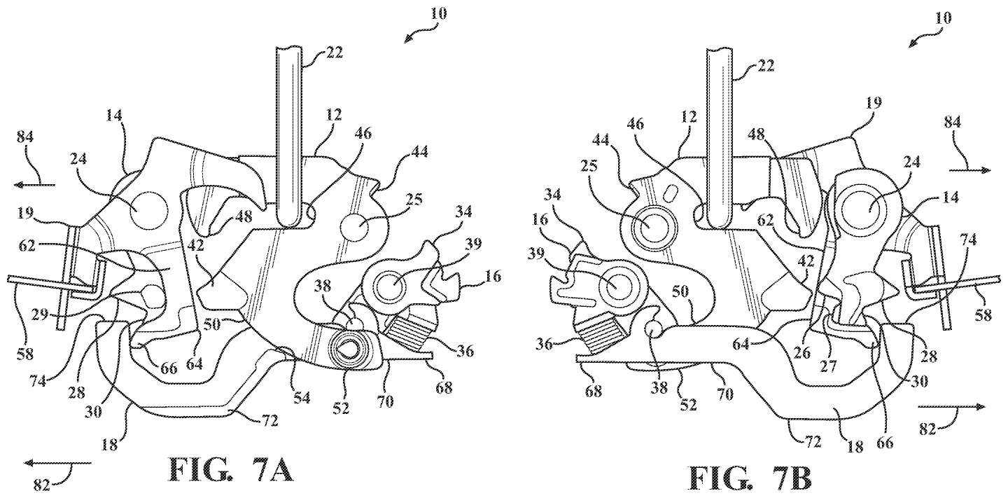

Now, when latch 10 is desired to be unlatched from within trunk 17 by a person locked with trunk 17 to allow the hood 13 to be opened, without a predetermined condition having been met, such as engine running or exceeding a predetermined speed, by way of example and without limitation, the person only need actuate auxiliary release member 56. Auxiliary release member 56 is an example of a release mechanism accessible from within the trunk 17 or frunk 17, and for example may be a mechanically activated release mechanism, or may be an electrically activated released mechanism. Selective actuation of auxiliary release member 56 causes cable/rod 58 to pull auxiliary release lever 19 in the direction of arrow 84 (FIGS. 7A, 7B), which causes drive arm 62 to engage and pull driven member 29 of primary pawl 14, and leg 66 to engage and push the region of coupling lever 18 immediately adjacent free end 74. Auxiliary release member 56 may include a power release mechanism such as a power release motor activatable by a switch or button located in the trunk 17, or frunk 17. Accordingly, the primary locking surface 26 of primary pawl 14 is moved out from engagement from primary locking surface 42 and simultaneously the coupling lever 18 is moved in translation along the direction of arrow 82 to pivot the secondary pawl 16 about pin 39 from the secondary locking position to the secondary unlocking position, whereupon ratchet 12 is caused to move under the bias of biasing member 40 directly from the primary closed position to the open position (FIGS. 8A, 8B). At this time, hood 13 may be moved to a fully open position.

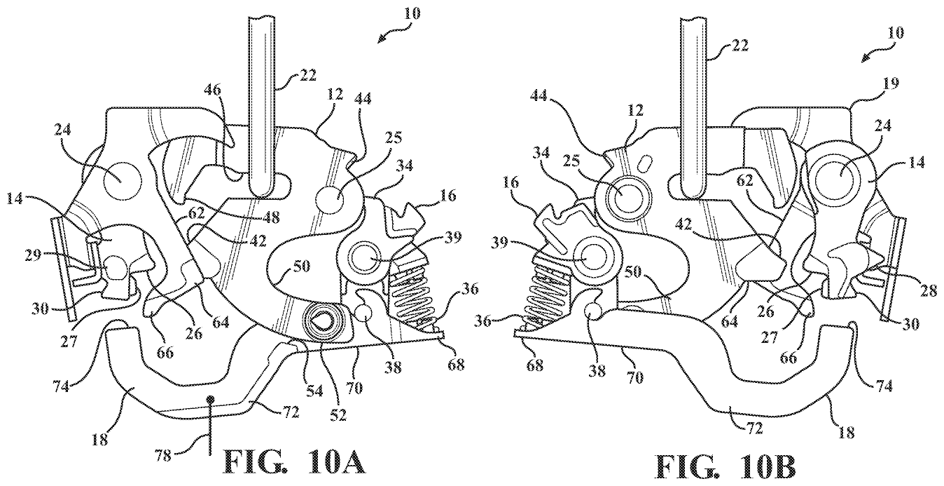

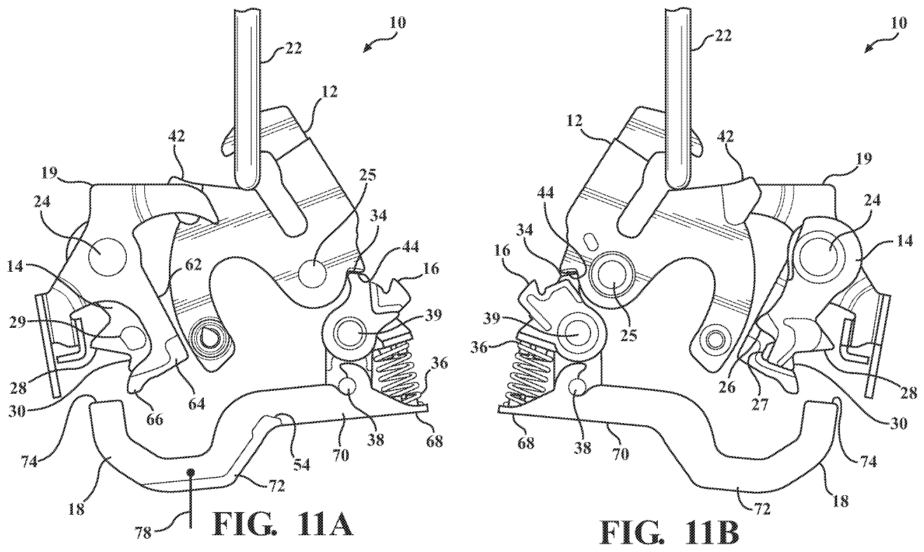

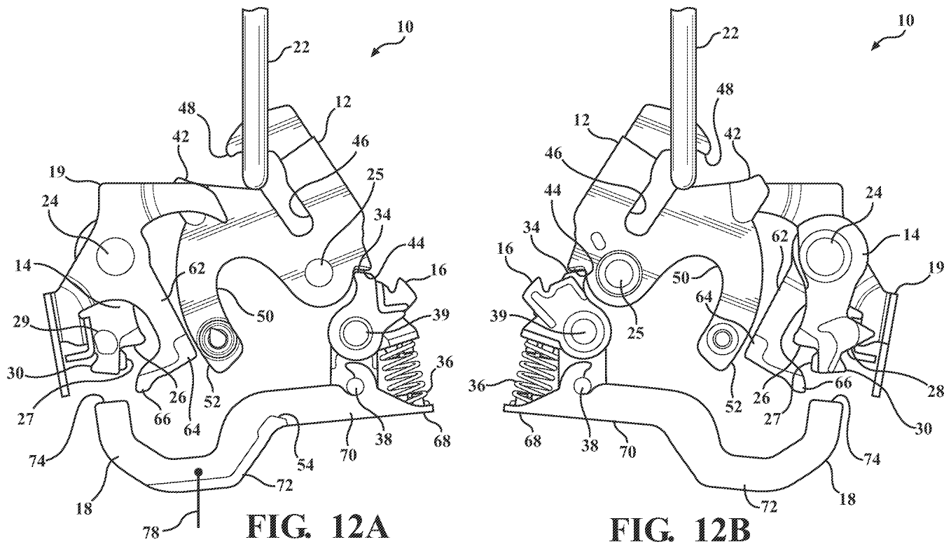

As discussed above, a predetermined condition can be implemented to prevent unwanted release of the ratchet 12 to the fully open position, thereby preventing the unwanted opening of hood 13. In both a normal unlatching mode performed from within the passenger compartment 37 and in an emergency unlatching mode performed from within the trunk 17, if the predetermined condition has been met, the ratchet 12 can be caused to move from the primary closed position to the secondary closed position, but not to the fully open position. With reference to FIGS. 9A-12B, a normal mode of unlatching the latch 10 from within the passenger compartment 37 is shown, wherein the predetermined condition is met, such as engine running or vehicle traveling in excess of a predetermined speed (e.g. 5 km/h). Upon the predetermined condition being met, sensor 80 signals actuator 76 to move coupling lever 18 in the direction of arrow 86 (FIG. 9A) to a disengaged position, wherein coupling lever 18 remains in the disengaged position as long as the predetermined condition exists. With this, it is to be recognized that the coupling lever 18 can be returned to the home position via actuator 76 upon the predetermined condition no longer existing. Upon being moved to the disengaged position, the coupling lever 18 is moved out from potential contact with primary pawl 14 and auxiliary release lever 19. As such, movement of the primary pawl 14 from the primary locking position to the primary unlocking position (FIGS. 10A-11B) in response to a first actuation of the release member (e.g. pawl release lever) causes the ratchet 12 to move from the primary closed position to the secondary closed position. However, it can be seen in FIGS. 12A, 12B that with the coupling lever 18 in the disengaged position, the first or any subsequent actuations of primary pawl 14 fails to cause ratchet 12 to move from the secondary closed position, due to the free end 74 of coupling lever 18 being disposed out of potential contact from primary pawl 14. Accordingly, the hood 13 is prevented from being able to open via actuation of auxiliary release member 56 as long as the predetermined condition is met and as long as the coupling lever 18 remains in the disengaged position.

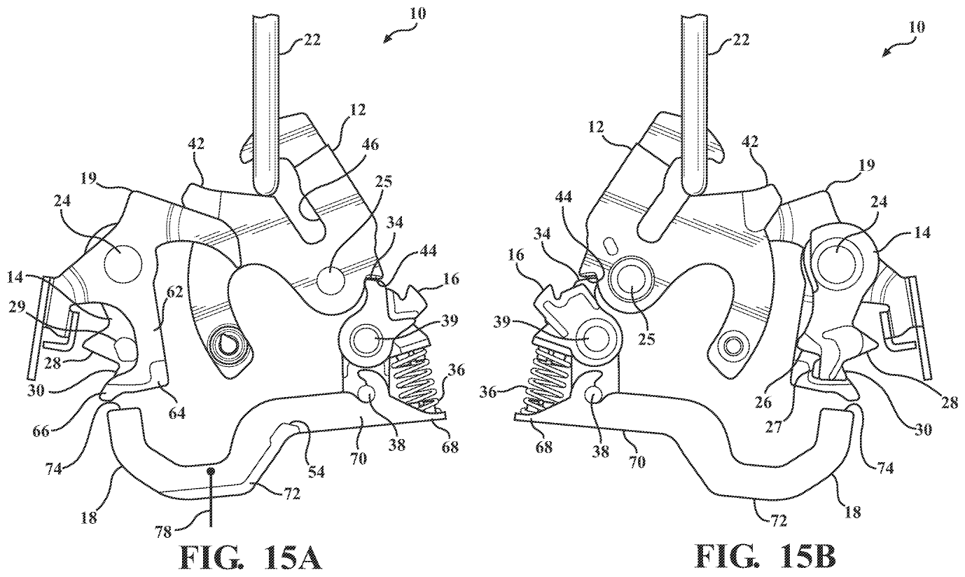

Now, when latch 10 is desired to be unlatched from within trunk 17 by a person locked with trunk 17 to allow the hood 13 to be partially opened, with the predetermined condition having been met, such as engine running or exceeding a predetermined speed, by way of example and without limitation, and the latch 10 operating in a safety mode, the person only need actuate auxiliary release member 56. Selective actuation of auxiliary release member 56 causes cable/rod 58 to pull auxiliary release lever 19, which causes drive arm 62 to engage and pull driven member 29 of primary pawl 14, but the leg 66 fails to engage the coupling lever 18 due to its being in the disengaged position, out from potential contact with auxiliary release lever 19. Accordingly, the primary locking surface 26 of primary pawl 14 is moved out from engagement from primary locking surface 42, whereupon ratchet 12 is caused to move under the bias of biasing member 40 from the primary closed position to the secondary closed position (FIGS. 15A, 15B). At this time, hood 13 may be moved to a partially opened position, thereby allowing air into the trunk 17 and allowing the person within the trunk 17 to voice outwardly therefrom, thereby being able to attract attention, and also at this time, hood 13 is maintained in the partially opened position and prevented from moving to a fully opened position, thereby preventing the trunk 17 or frunk 17 to open in an unsafe operating condition of the vehicle such as when the predetermined condition exists. For example, hood 13 is prevented from being opened when the vehicle 10 is above a speed, such as five kilometers per hour, which may for example in the configuration where hood 13 is a front hood 13 which encloses a front trunk 17, also referred to as frunk 17 and configured to swing upwardly and rearward towards a fully opened position as illustratively shown in FIG. 1A, cause the hood 13 to be unsafely propelled upwards if caught by the air moving at the vehicle at speed thereby obscuring the view of a driver and/or impacting the windshield of the vehicle. The predetermined condition may therefore be set based upon the desired level of safety to the vehicle and driver, as well as for the safety of an entrapped person within the trunk 17, or frunk 17. Further yet, as described above, upon the predetermined condition no longer existing, as sensed by sensor 80, the latch 10 can be shifted to a normal mode of operation, for example the coupling lever 18 can be returned to the engaged position to allow a second actuation of auxiliary release member 56 to cause the ratchet 12 to move to the fully open position, thereby allowing the hood 13 to be opened.

The above description has referred to the double pull actuation of the latch 10 and ratchet 12 that can be selectively prevented from transitioning from the secondary closed position to the fully open position. As described above, the coupler 18 can be selectively actuated such that a second pull or actuation of the primary pawl 14 does not cause concurrent actuation of the secondary pawl 16, thereby preventing the ratchet 12 from being released by the secondary pawl 16. Put another way, the secondary pawl 16 remains in position to block the ratchet 12 from releasing the striker, while the primary pawl 14 continues to be actuated to no effect (after the first actuation or pull imparted on the primary pawl 14). Thus, the above-described latch 10 includes a mechanism disposed within the latch 10 to effect whether the secondary pawl 16 will ultimately be actuated.

In an alternative aspect, control of the latch 10 may be effected by controlling whether the latch 10 is itself actuated by receiving an actuating or pulling force when the predetermined condition is met. For purposes of further discussion, the predetermined condition will be described relative to a threshold speed (e.g. 5 km/h). The above-described latch 10 and its component parts may be generally referred to, but with the coupler 18 remaining in an active and connected state (the normal operative state described above, where a second actuation of the primary pawl 14 causes actuation of the secondary pawl 16). However, it will be appreciated that other double pull latch mechanisms may be used with the below-described functionality, in which double pull actuation transitions a double-pull latch and ratchet from a primary closed position (primary closed state or primary latched state) to a secondary closed position (secondary closed state or secondary latched state) following a first pull, and from the secondary closed position to the fully open position (fully open state). Such latches may include various pawls and ratchet designs, and a skilled artisan will appreciate that the described functionality herein the applicability to various double-latch designs.

Having now described the above double-pull latch mechanism, other latch mechanisms and associated systems will now be described.

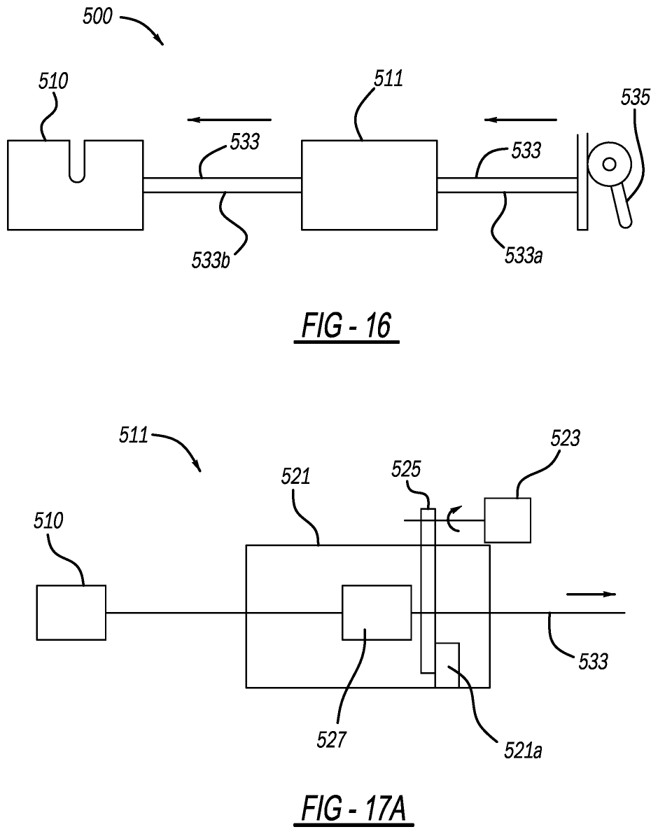

FIG. 16 illustrates a schematic view of a double pull latch system 500, including latch 510, cable 533, switch 511, and release handle 535. The system 500 is configured to decouple or block the second “pull” of the system when a predetermined condition is present (i.e. when the vehicle is driving faster than 5 km/h). By blocking or preventing the second pull to be imparted on the latch 510, the latch 510 will not transition from the secondary latched state to the fully open state. The system can continue to receive a pull following the first pull, and such a pull will not cause the latch 510 to open fully.

The switch 511, as shown, is disposed in line with the cable 533, and effectively joins a first cable portion 533a with a second cable portion 533b. The first cable portion 533a may extend between the switch 511 and the handle 535, and the second cable portion 533b may extend between the switch 511 and the latch 510. The switch 511 is operable to go from a “normal” operating mode, in which a pull on the first portion 533a is transferred to the second portion 533b to complete the pulling force on the latch 510, to a decoupled or blocked mode such that a pull or actuation of the first portion 533a is not transferred to the second cable portion 533b, so that the second cable portion 533b does not actuate the latch 510. In one aspect, a decoupled mode separates the sections of the cable 533, allowing the pull to be completed on one side; in a blocked mode, the cable 533 sections remain attached, but the cable cannot be pulled.

In the normal mode, for example when a first predetermined vehicle condition is met, such as operating the vehicle below a threshold speed such as 5 km/h, a first pull and a second pull are allowed to be transferred sequentially to the latch 510, with the switch 511 not decoupling or blocking either the first pull or the second pull. In the decoupled or blocked mode, for example when a second predetermined vehicle condition is met, such as exceeding the threshold level (or put another way when the first condition is not met), the first pull may be permitted, but following the first pull, the second pull will be prevented via blocking or decoupling.

The components of the switch 511 are described in further detail below. The switch 511 may operate in a different manner to achieve the desired blocking, decoupling, or disabling of the actuation of the latch 510.

In one aspect, the switch 511 may receive signals from the vehicle ECU (determined via vehicle sensors) related to the predetermined condition, such as receiving a signal regarding the speed of the vehicle. When the speed varies between being below the threshold level and above the threshold level, the switch 511 will operate to engage/disengage the second pull (allow or block the second pull from reaching the latch 510). In this aspect, the switch 511 may undergo a high number of cycles as the vehicle is traveling, without regard to whether or not a first pull has occurred or whether opening of the hood 13 is desired.

In another aspect, the switch 511 may operate based on multiple signals. For example, the switch 511 may be operable to disengage a second pull in response to the combination of a first pull having occurred and the driving speed being greater than the threshold level. For example, if the vehicle is traveling greater than the threshold speed, and the manual release is activated, the primary pawl 514 will be pulled and the ratchet 12 and latch 510 will transition to the secondary latched state. With the primary pawl 514 having been actuated a first time by the first pull, a second pull will not actuate the latch 510 when the speed is above the threshold level. In the case of a physical mechanism that blocks or decouples the second pull, the system will detect that the first pull has occurred and actuate the blocking or decoupling mechanism. In another aspect, the blocking/decoupling mechanism may be actuated as soon as the threshold condition is present, but will not physically move into position until the first pull occurs, where movement of the components of the mechanism only allows movement into the blocking or decoupling position following the first pull.

In similar aspect, with the vehicle speed below the threshold level, if the first pull occurs, the latch 510 will be in the secondary latched state. If the vehicle begins traveling above the threshold speed, a second pull will not actuate the latch 510 further. However, if the vehicle does not begin traveling above the threshold speed, a second pull will actuate the latch 510 and the latch will transition to the fully open position.

In the above case requiring an additional signal related to the first pull occurring, the switch 511 will cycle fewer times relative to operating the switch every time the speed changes above/below the threshold level. Instead, the switch 511 will only cycle after a manual release or first pull has occurred and the speed increases beyond the threshold level. In the absence of a first pull, cycles of the engagement/blocking arrangement of the switch 511 will not occur.

In another aspect, the switch 511 may be configured such that the normal operating condition or general operating condition is that the second pull is blocked or disengaged. In response to a combination of a first pull and a signal that the speed is below the threshold level, the second pull will be allowed and engaged. In this aspect, the switch 511 will cycle a medium number of times (every time the manual release is actuated when the vehicle is parked or traveling below the threshold level).

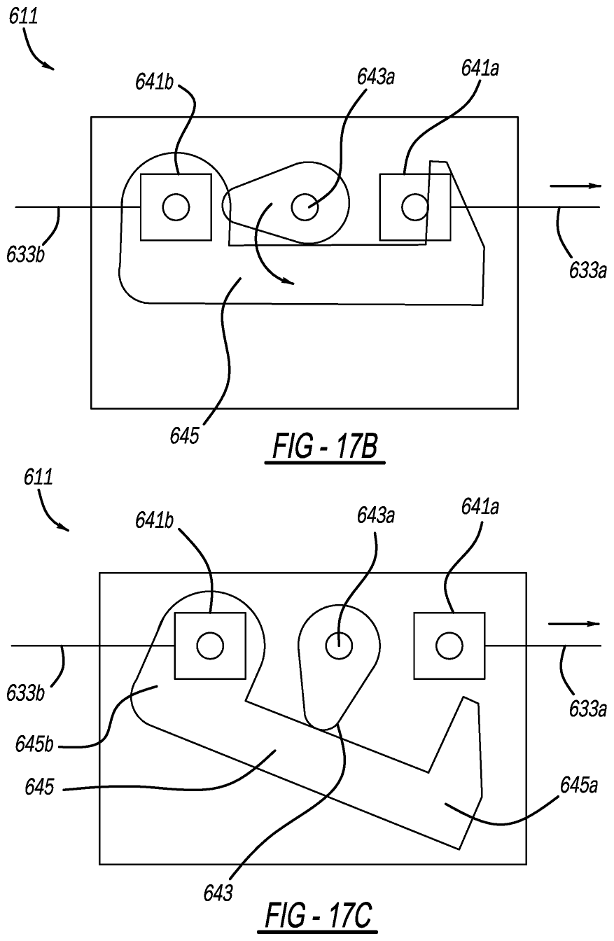

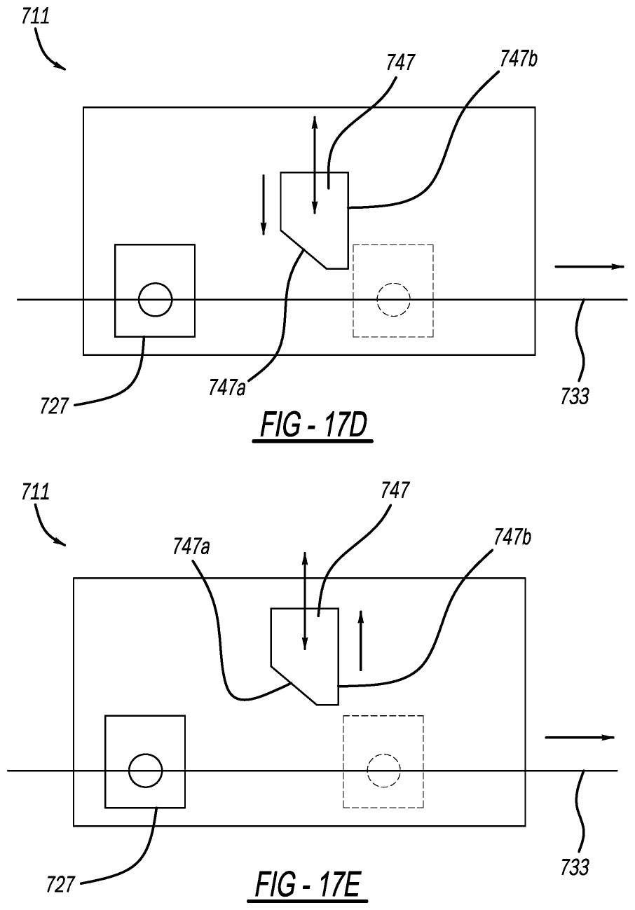

FIG. 17A illustrates a schematic view of the switch 511 according to one aspect of a control scheme. Switch 511 includes housing 521. Cable 533 extends into and out of the switch 511. A motor 523 is operatively coupled to a moveable barrier 525. A ferrule 527 is fixed to the cable 533 within the housing 521. The moveable barrier 525 allows the cable 533 to pass therethrough, but blocks the ferrule 527 from being pulled to the right in the figure. In response to a signal indicating that the vehicle speed is above the threshold level, the moveable barrier 525 is positioned in the path of the ferrule 527 (or the barrier 525 may be positioned in the path of the ferrule in the absence of a signal indicating a speed below a threshold level). The housing 521 may include a flange 521a or the like positioned behind the moveable barrier 525 to brace the moveable barrier 525 against a force exerted on the barrier 525 by the ferrule 527 in response to a pulling force. In response to a signal indicating that the vehicle speed is below the threshold level, the moveable barrier 525 is actuated out of the path of the ferrule 527, such that a pulling force on the cable 533 causes the cable 533 to be pulled and for the pulling force to be applied to the latch 510.

FIGS. 17B and 17C illustrates a schematic view of another switch 611 that can selectively block or disengage a double pull latch located downstream of the switch 611. Cable 633 has first portion 633a and 633b with head portions 641a, 641b fixed to respective ends of the cable portions 633a, 633b. Switch 611 includes an actuatable cam 643 pivotable about a pivot axis 643a. A connecting hook 645 includes a hook head 645a at one end and is pivotable about an opposite end 645b. In one aspect, the connecting hook 645 may be fixed to one of the head portions 641a, 641b and may be pivotable relative thereto, with the hook head 645a being selectively engageable with the other of the head portions 641a, 641b. As used herein connecting hook may also be referred to as connecting lever.

The cam 643 is moveable between a first position and a second position. The connecting hook 645 may be biased toward an connected position in which both cable portions 633a, 633b are coupled to each other via the connecting hook 645. In the first position of the cam 643, the connecting hook 645 is in the connected position. In the second position of the cam 643, the connecting hook 645 is pivoted to a disconnected position, such that the cable portion 633a, 633b are de-coupled, and a pulling force on the first portion 633a is not imparted on the second portion 633b, and therefore the downstream double pull latch is not actuated in response to a pulling force. The cam 643 is actuatable between the first and second position in response to a vehicle speed signal received at the ECU, and the cam is controllable via a motor or other actuator in communication with the ECU.

Thus, when the vehicle speed is above a threshold level, the switch 511 of FIG. 16A blocks the cable 533 from being pulled, while the switch 611 (FIGS. 17B and C) disengages the cable 633 from being actuated. In both cases, the downstream double pull latch does not receive a pulling force from the cable 533/633.

In another aspect, switch 711 is shown in FIGS. 17D and 17E. Switch 711 includes a ferrule 727 fixed to cable 733, and a spring slider 747. The spring slider 747 includes a ramped surface 747a facing the ferrule 725 when the ferrule 725 is in a non-actuated or un-pulled position. The ramped surface 747a allows the ferrule 727 to push the spring slider 747 upwardly in the figure so that the ferrule 727 will move past the spring slider 747, even when the spring slider 747 is in a blocking position (shown in FIG. 17D). The spring slider 747 also includes blocking surface 747b on the opposite side relative to the ramped surface 747a, and facing the ferrule 727 after the ferrule 747 has moved past the spring slider 747 following a first pull.

The spring slider 747 is moveable between a first, blocking position (FIG. 17D) and a second non-blocking position (FIG. 17E). In the blocking position, after the ferrule 727 has been pulled a first time (which is allowed due to the ramped surface and spring) and moved beyond the spring slider 747, the ferrule 727 is blocked from returning to its non-actuated position. Put another way, the ferrule 727 is kept in a position following a first pull, and cannot be pulled a second time, and the downstream latch therefore cannot be actuated a second time.

In the non-blocking position, the ferrule 727 is allowed to return to its non-pulled position. Accordingly, the ferrule 727 may be pulled a second time to actuate the downstream latch a second time.

Thus, in response to a signal that a vehicle is traveling above a threshold level (or in response to another vehicle condition such as a particular driving mode), the slider 747 may be positioned in its blocking position, which allows a first pull but blocks a second pull from occurring while the slider is in its blocking position.

In response to a signal that the vehicle speed is below a threshold level (such as the vehicle being parked), the slider 747 is moved to its non-blocking position, allowing the cable 733 and ferrule 727 to be pulled a first time and also a second time. The slider 747 may be biased to either the blocking or non-blocking position and actuated against the bias, or the slider 747 may be positionable directly by a motor/actuator. The nominal position of the slider may either be the blocking or non-blocking position, with the determination of the vehicle state being used to move the slider 747 from the nominal position.

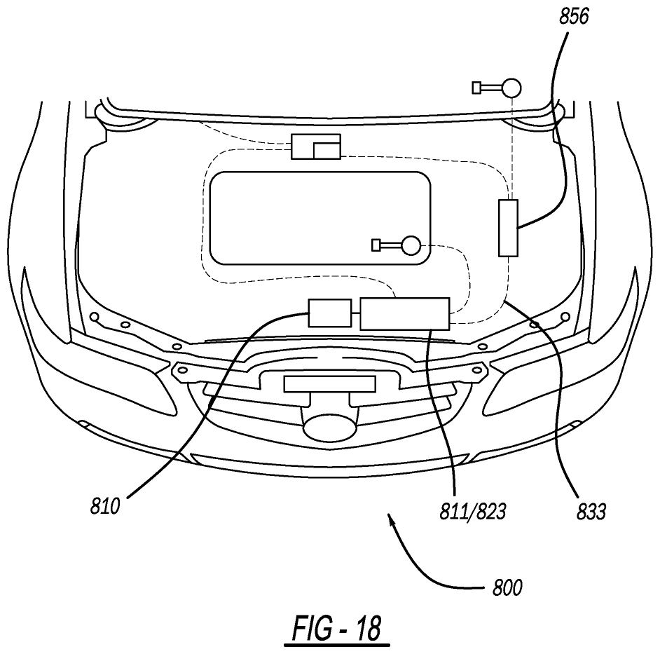

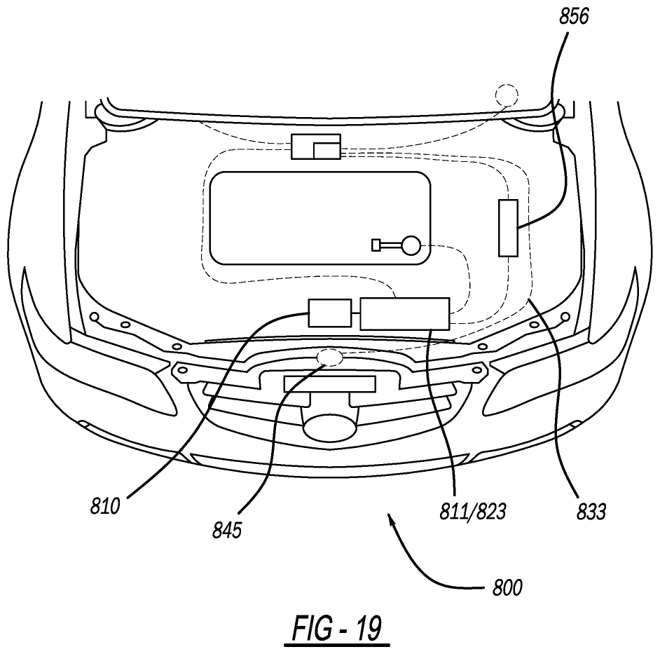

FIGS. 18 and 19 illustrate a system 800 having switch 811. Like previously described switches, switch 811 operates to block/disengage actuation of cable 833 from actuating a downstream double pull latch 810. The system 800 is shown in two variants. A first variant, shown in FIG. 18, includes latch 810, which is a double pull latch operable via manual release. Handles within the vehicle compartment and also inside of the hood are joined at BDC clutch, which is joined to switch 811, which may also be described as FMVSS actuator, with latch 810 downstream from switch 811. ECU is in communication with the switch 811 and sends signals regarding the vehicle state, such as the vehicle speed. Thus, a pull from the handle within either the vehicle or within the frunk/hood is imparted into the switch 811, and the blocking or decoupling mechanisms described above determine whether the switch is actuated

A second variant, shown in FIG. 19, includes an electrical release actuator as part of the ECU. The electrical release actuator receives signals from within the vehicle or a sensor at the front of the vehicle, and this actuator generally replaces the manual release that is typically within the vehicle cabin. A manual safety release may be disposed under the hood, which operates similar to FIG. 18. The second variant may further include a swiveling striker and a separate pop up element as part of the latch 810.

FIG. 19 illustrates the second variant of this arrangement, and provides further detail regarding the operation of the system 800. FIG. 19 also illustrates front sensor 845 disposed at the front of the vehicle, which can be used to send a signal to the ECU to open the hood via actuator 856. The sequence of operating the system 800 (FIG. 18 or 19) will first be described with the vehicle speed being below 5 km/h, and will later be described with vehicle speed being above 5 km/h.

With the speed below the threshold level, the driver or a person positioned at the front sensor 845 may initiate a release signal (via a button or the like), which is sent to the ECU. The ECU supplies power to powered release actuator 856 twice, which causes two actuations from the release actuator 856. This double supply of power mimics a manual double pull operation by actuating the cable 833 twice. The latch 810 first moves into the secondary latched state after the first supply of power (the first pull), and after the second pulse of power (the second pull), the latch 810 moves to the fully open position.

From inside the frunk, the operator may pull the manual lever twice. After the first pull, the latch 810 moves to the secondary latched position. After the second pull, the latch 810 moves to the fully open position.

Thus, in both cases, whether actuated via the ECU and actuator or via the manual lever inside the hood, the first pull may be followed by the second pull to fully release the hood, with the pull of either cable being transferred to the latch 810 via the switch 811.

With continued reference to FIG. 19, with the speed above the threshold level (or in the case of another signal to prevent full opening of the hood), the operation of the system 800 will now be described. The ECU receives a signal from the vehicle speed sensor that the speed is above the threshold level (or that a speed is not below the threshold level). The ECU supplies power to the motor 823 associated with the switch 811, placing the switch 811 in a blocked/disengaged/safety/security state. If the speed drops below the threshold level, the motor 823 may reverse and the switch 811 may return to the “normal” or parked or passageway operating state.

The driver or person at the front sensor 845 may initiate an opening of the hood. The signal to open the hood is sent to the ECU. The ECU supplies power just once to the actuator 856, causing a first pull or a single pull. The switch 811 allows the first pull, and the latch 810 moves to the secondary latched position, but not to the fully open positon. If the ECU supplies power a second time to the actuator 856 (or a third time), the switch 810 will not allow this subsequent pull to pass to the latch 810. Accordingly, the latch 810 stays in the secondary latched position. However, with the ECU aware that the threshold condition is in place, the ECU may not even pass on a signal to the actuator in response to further actuations of the button (or the like).

From inside the frunk, the operator may pull the manual release lever. The first pull is allowed through the switch 811 and passes to the latch 810, such that the latch 810 moves to the secondary latched position. The operator may then pull the latch a second time (or a third time). However, due to the signal from the ECU that the vehicle speed is above the threshold level, the switch 810 does not pass the subsequent manual release pull through the switch 811, so it does not pass to the latch 810. The latch 810 therefore remains in the secondary latched position.

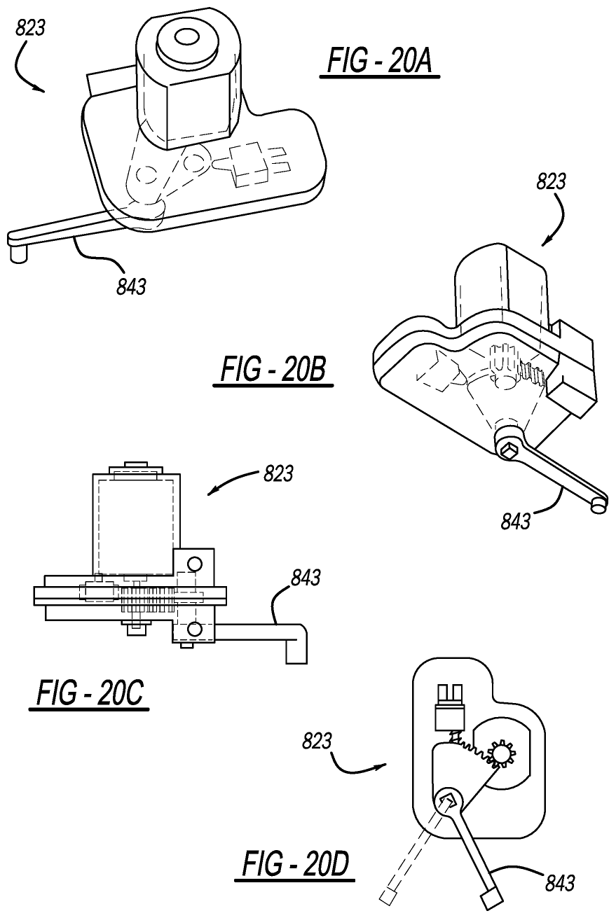

One aspect of the switch 811, including motor 823 and internal components of the switch 811, is shown in further detail in FIGS. 20A-D and 21A-D. It will be appreciated that other switch mechanisms described herein could also be used in system 800 and operate as described above. Cable 833 includes first portion 833a and second portion 833b. First portion 833a has a manual portion that is coupled to a handle inside the frunk and release actuator portion that is coupled to the electrically actuated release actuator. Thus a manual pull or a pull from the actuator will actuate the same terminal end of the first portion 833a.

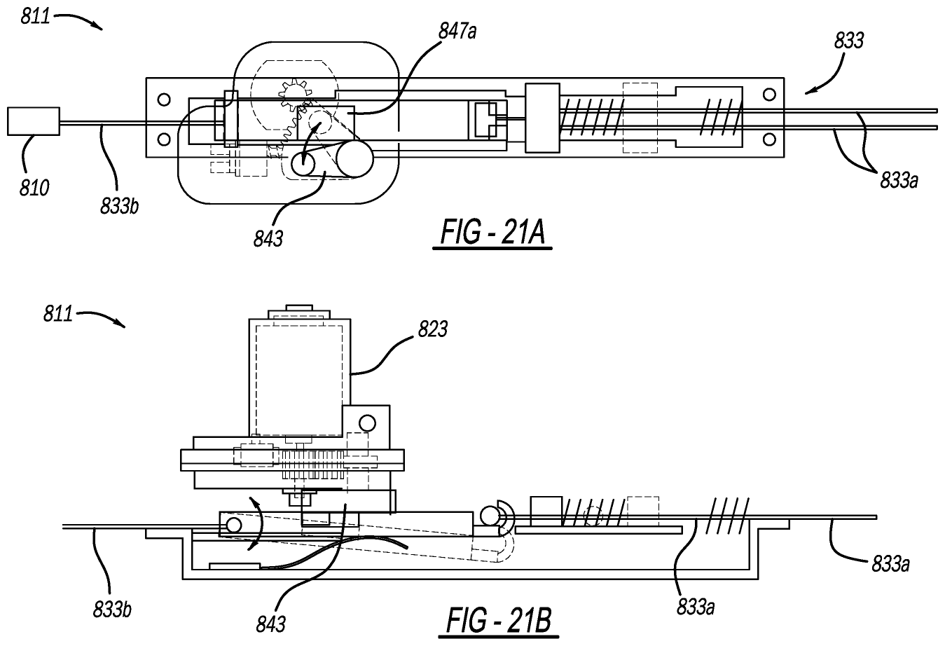

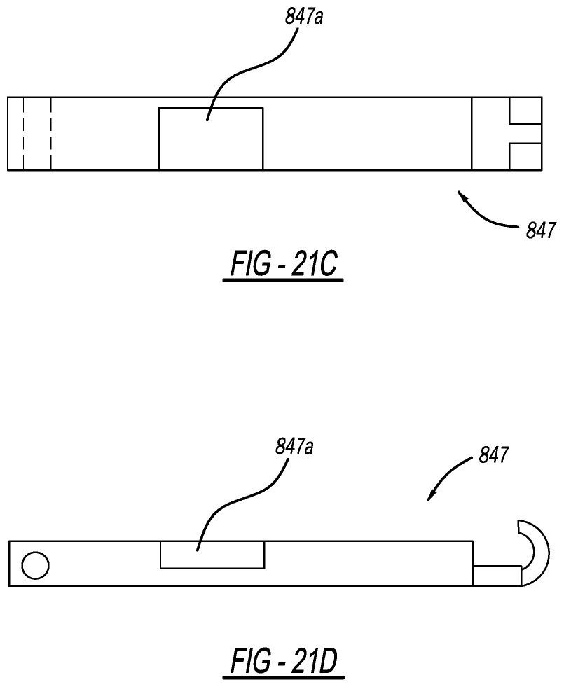

Connecting hook 847 is biased to a connected position (which couples first cable portion 833a to second cable portion 833b), and is moveable away from the connected position in response to actuation of cam 843 (which may also be referred to as a control lever). The cam/control lever 843 in FIG. 20A-D illustrates a rod with a downward projection. The shape of the cam/control lever 843 in FIG. 21A-D is slightly different, but also includes the downward projection. Connecting hook may also be referred to as connecting lever.

Cam 843 is moveable, via motor 823, between a first position (passageway status where double pull actuation is permitted) and a second position (security status where a double pull is blocked/decoupled). The connecting hook 847 may include a ramped surface 847a, such that pivotable movement of the cam 843 causes the connecting hook to pivot when the pivot axes of the cam 843 and connecting hook 847 are transverse. The cam 843 moves laterally into engagement with the ramped surface, causing downward movement of the connecting hook 847 to the disconnected position via the downward projection of the cam 843 moving across the ramped surface 847a. In the second position of the cam 843, the connecting hook 847 is moved to de-couple the first cable portion 833a from the second cable portion 833b. In one aspect, a 50 degree pivot of the cam 843 is sufficient to pivot the connecting hook 847 to the second position.

As shown in FIG. 21A-B, cable 833b remains connected to the connecting hook 847 regardless of the position of the cam 843 and whether the connecting hook 847 is connected to cable 833a.

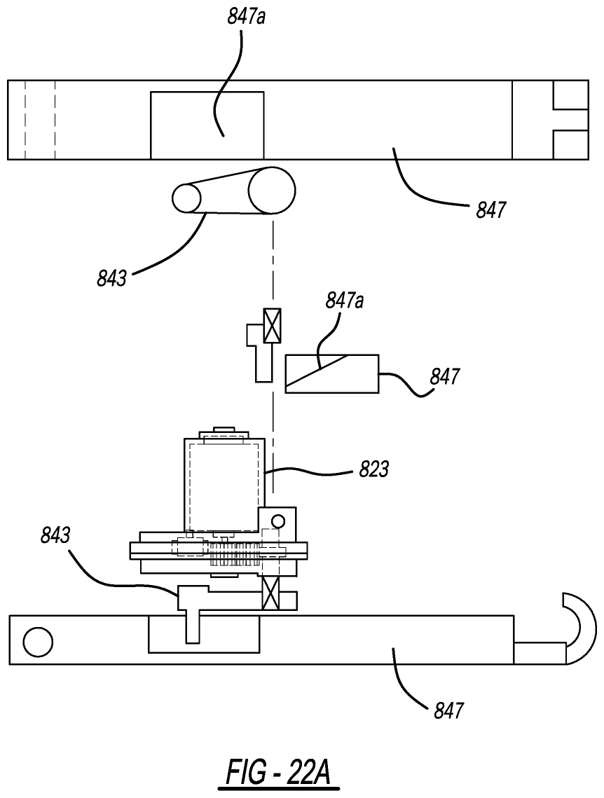

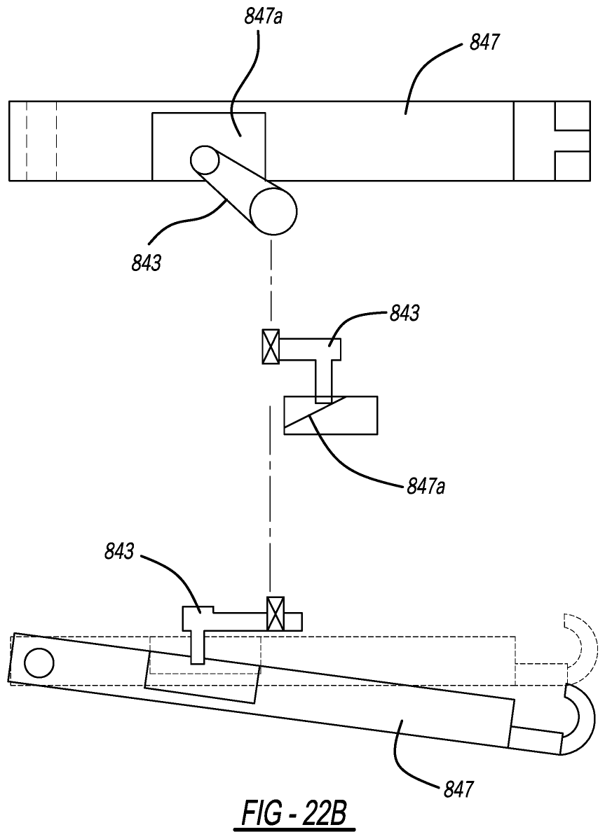

FIGS. 22A-B illustrate additional views of an aspect of switch 811 and the relationship between cam 843 and connecting hook 847 more clearly, with other components of the switch 811 removed for clarity. As shown in FIG. 22A, the cam 843 is in passageway status when the vehicle is traveling below the threshold speed, the cam 843 is not engaged with the connecting hook 847, and the connecting hook 847 is in the passageway status, allowing the cable 833 to be pulled and passed to the latch 810. FIG. 22A illustrates both the top and front view of the connecting hook 847 and cam 843, as well as a cross-sectional end view of the connecting hook 847 and cam 843 disposed aligned between the top and front views.

In FIG. 22B, the cam 843 is pivoted into engagement with the connecting hook 847, in contact with the ramped surface 847a (shown in the cross-sectional end view), such that connecting hook 847 is pivoted downward into security status (shown in the front view at the bottom of FIG. 22B). The cable 833 is de-coupled when the connecting hook 847a is in this position. In the embodiment illustrated in FIG. 22A-B, the cable 833 may be unlocked or de-coupled prior to a first pull, based on the position of the cam 843.

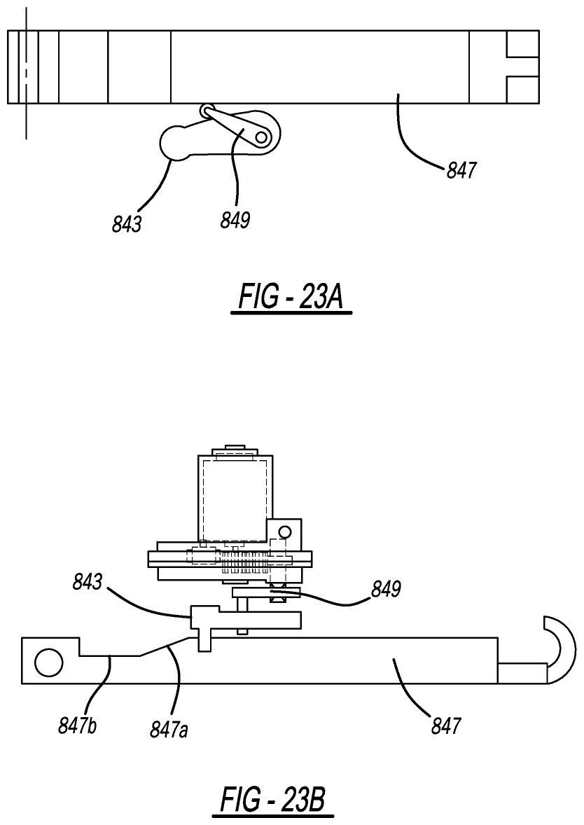

FIGS. 23A-B through 26A-B illustrate a variant of switch 811, in which the cable 833 is unlocked/de-coupled following a first pull and before a second pull when the vehicle speed is above the threshold level, even with the cam 843 actuated prior to a first pull. In the passageway status (vehicle below threshold level), the cable 833 is coupled and locked, allowing both a first pull and second pull on the cable 833 to pass to the latch 810. Similar to the above variant, the position of the connecting hook 847 determines whether or not the cable 833 is coupled.

FIGS. 23A and 23B illustrates cam 843 and connecting hook 847 in passageway status, and without cable 833 being pulled. The cam 843 is not yet actuated, and connecting hook 847 can reciprocate in response to pulling actions without being blocked. In this variant, switch 811 also includes a gear output lever 849. Gear output lever 849 is actuatable by the ECU, and holds the cam 843 in the passageway position, allowing the connecting hook 847 to stay biased into the connected position. The cam 843 is biased toward the connecting hook 847, but is held back from engaging the connecting hook by the gear output lever 849, which in this variant is the lever that is directly controlled by motor 823. As shown in FIG. 23A-B, the gear output lever 849 has a downward projection that holds the cam 843 against its bias. The gear output lever 849 is free to pivot over the connecting hook 847 without actuating the connecting hook 847, but the cam 843 would contact the side of connecting hook 847 if allowed to move according to its bias when lever 849 moves.

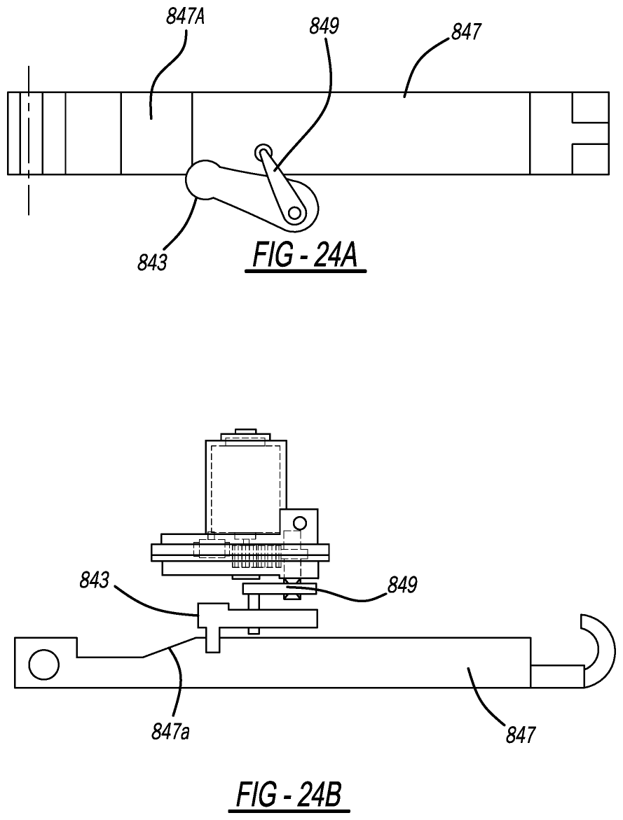

FIG. 24A-B illustrates the state of gear output lever 849 and cam 843 with the vehicle traveling above the threshold speed and security status being enabled by the ECU, but before the cable 833 has been pulled a first time. In this state, the gear output lever 849 is pivoted from a passageway status position (first position) to a security position (second position) by motor 823. The cam 843 is biased toward the connecting hook 847, and is in an intermediate position and in contact with the side of the connecting hook 847, but has not yet caused the connecting hook 847 to move downward. The connecting hook 847 does not have a ramped surface in line with the cam 843 at this actuation stage in this variant. Rather, ramped surface 847a is disposed offset from the cam 843 prior to the cable being pulled a first time. Accordingly, prior to pulling the cable 833 and after security status is enabled by the ECU, the connecting hook 847 is still in the connected position, and a first pull of the cable 833 is allowed and will occur, even when vehicle speed is above the threshold.

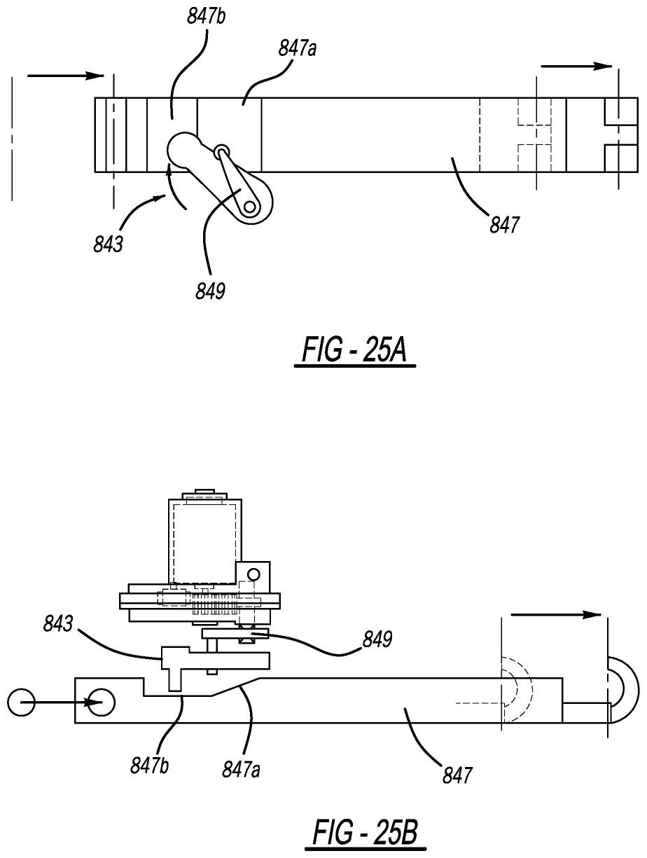

FIG. 25A-B illustrates the first pull occurring even while in security status. In this state, the gear output lever 849 is in the same position as FIG. 24A-B. The connecting hook 847 has been pulled to the right by the cable 833 in FIG. 25A-B, and the first pull has been passed on to the latch 810. With the connecting hook 847 pulled to the right, the ramped surface 847a passes the cam 843, and the cam 843 moves into a recessed area 847b, such that the cam 843 is disposed over the connecting hook 847 and over the recessed area 847b (shown in FIG. 25A). The ramped surface 847a is aligned with the end of the cam 845, but not in contact with the cam 843 because it has been pulled beyond the cam 843. The connecting hook 847 has therefore not yet been moved into the disconnected position.

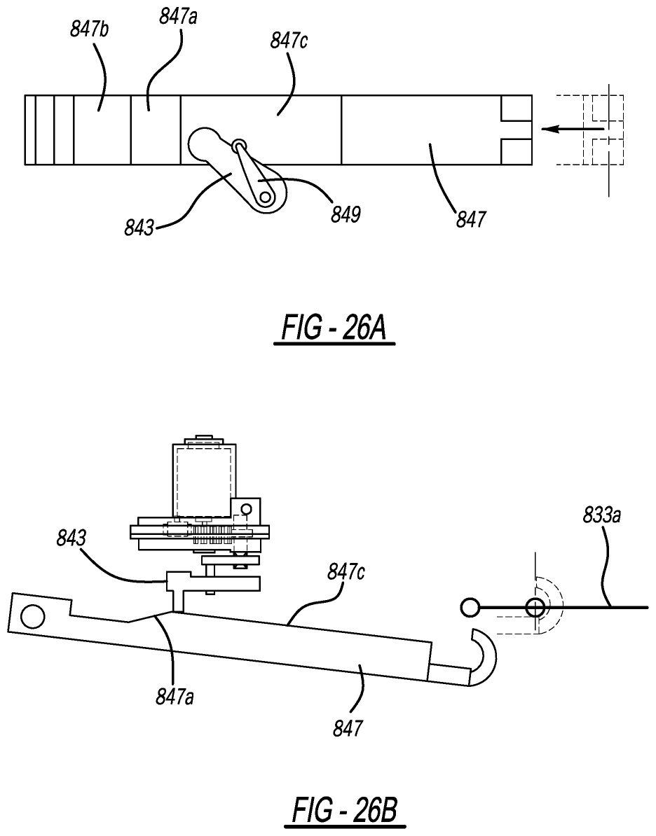

FIG. 26A-B illustrates the connecting hook 847 after the first pull and after it has been allowed to return. The connecting hook 847 translates back to the left during its return travel and is shown in its returned position. The end of the cam 843 contacts the ramped surface 847a during the return travel, forcing the connecting hook 847 down, and the cam 843 ultimately makes contact with an upper surface 847c after sliding along the ramped surface 847a. The cam 843 therefore forces the connecting hook 847 downward and out of engagement with the end of first cable portion 833a. A second pull of the cable 833 will be allowed by a handle or actuator, but will not be passed on to the connecting hook 847, and the therefore the pull of the cable 833 will not be passed on to the latch 810 due to the decoupling at the switch 811 after the first pull.

Thus, in response to the ECU placing the switch 811 in security status prior to a first pull, a first pull may still be performed on the cable 833 and passed to the latch 810, with the disconnect occurring upon a return of the cable 833 and connecting hook 847 following the first pull.

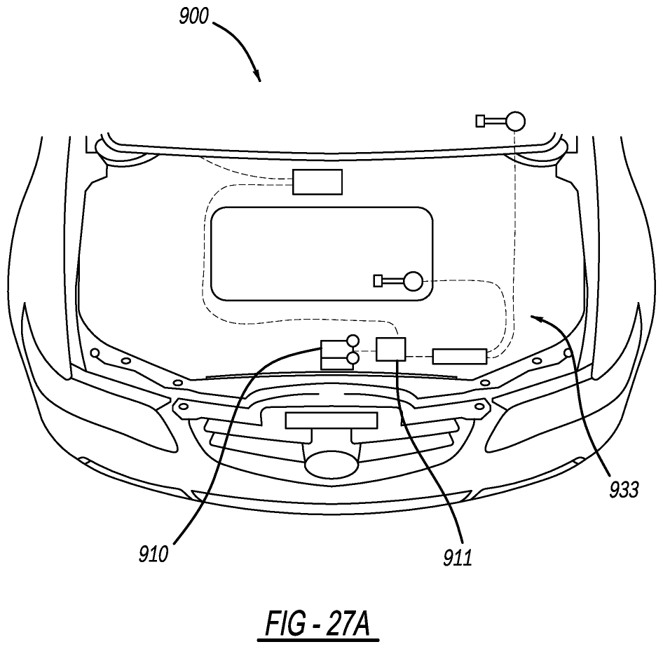

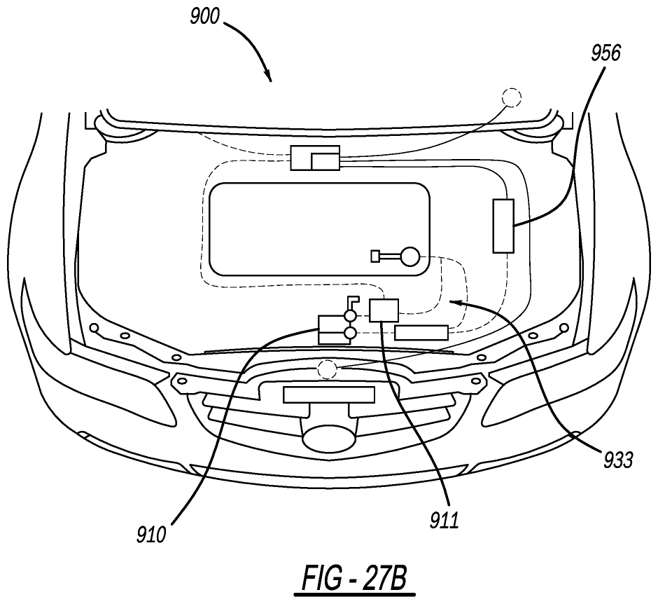

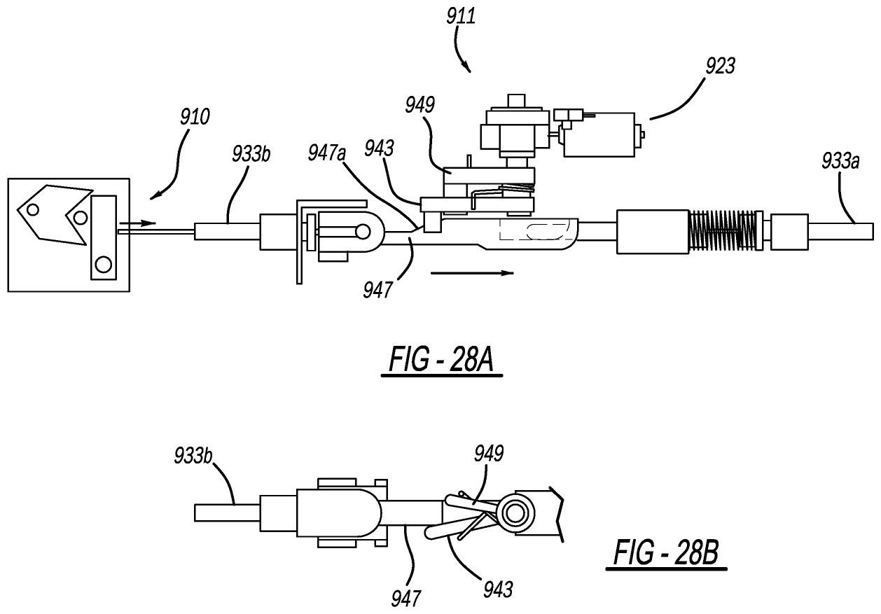

FIG. 27A-B illustrates yet another latch system 900 having a switch 911 and a latch 910. The latch 910 may be any latch that releases a ratchet from a primary latched position to a secondary latched position following a first pull and to a fully open position following a second pull by release cable 933. FIG. 27A illustrates manual release levers in both the frunk and the passenger compartment. The switch 911 is disposed on the cable 933 that extends from the manual release levers to the switch 911. As shown each manual lever has a cable extending therefrom, which are joined together such that a single cable extends into switch 911, which single cable will be pulled by either manual release lever.

FIG. 27B illustrates the system 900 having a latch 910 with a separate safety hook, and an electronic release actuator 956 (actuated via the cabin or a front sensor, for example) in parallel with a mechanical actuator located within the frunk. The cable from the manual lever in the frunk and the cable from the electronic release lever are joined together, with a single cable extending to latch 910. The switch 911 is attached to the manual release cable extending from the frunk. The safety hook of latch 910 is opened via the switch 911 and the handle inside the hood depending on the state of the switch 911, with the ECU controlling actuation via actuator 956. The switch 911 does not affect the pull caused by the ECU. The manually pulled cable is coupled to the cable of the actuator, so a first pull is always allowed by the manually pulled cable.

FIG. 28A-B shows one aspect of the switch 911 (which may operate similarly to switch 811 described previously) in a state with the vehicle speed above the threshold level such that the gear output lever 949 is in its second position (after actuation by motor 923 and pivoted over connecting hook 947) and cam 943 is therefore biased against the side of connector hook 947, but prior to a first pull, so connecting hook 947 is not yet pivoted downward, and the connection between cable portions 933a, 933b is not yet de-coupled. The latch 910 is shown in the primary latched state, having not yet been actuated by a first pull. Connecting hook 947 may also be referred to as connecting lever.

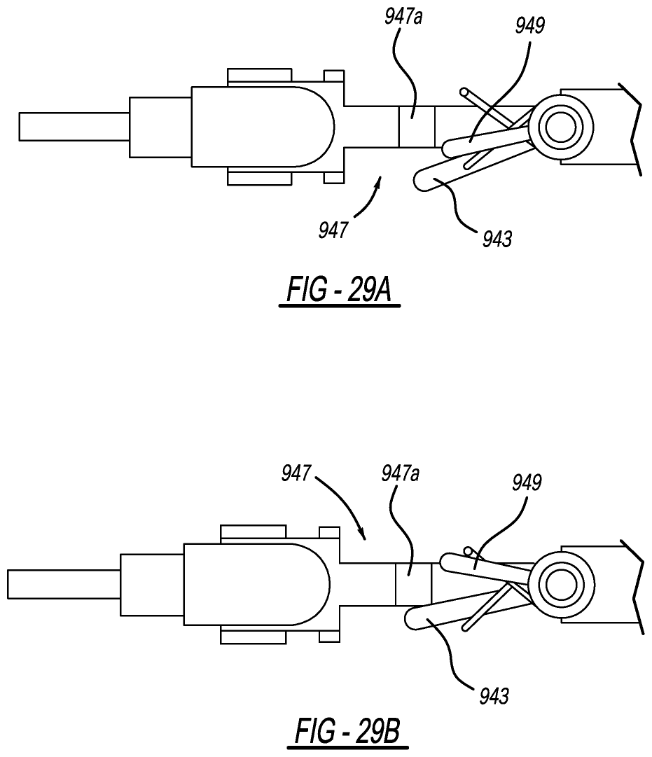

FIG. 29A-B shows the changing position of output lever 949 and cam 943 in their passageway states when the vehicle speed is below the threshold level (FIG. 29A) and also the safety state when the vehicle is above the threshold level (FIG. 29B), but prior to a first pull. The output lever 949 holds the cam 943 away from the connecting hook 947 in FIG. 29A (and when pivoted back to the passageway state will force the cam 943 back away from the connecting hook 947). As shown in FIG. 29B, prior to pulling on the Bowden cable 933, the output lever 949 will pivot further than the cam 945, because the cam 945 becomes blocked by the yet to be pulled connecting hook 947. In both vehicle speed states, prior to the first pull, the connecting hook 947 and the connection between cable portions is not yet de-coupled. Following the first pull, the cam 943 is allowed to shift inward from the position shown in FIG. 29B, the return movement of the connector hook 947 causes the connector hook 947 to move downward and decouple as ramped surface 947a engages the end of the cam 943, which was able to shift into the path of the connecting hook 947 during the first pull.

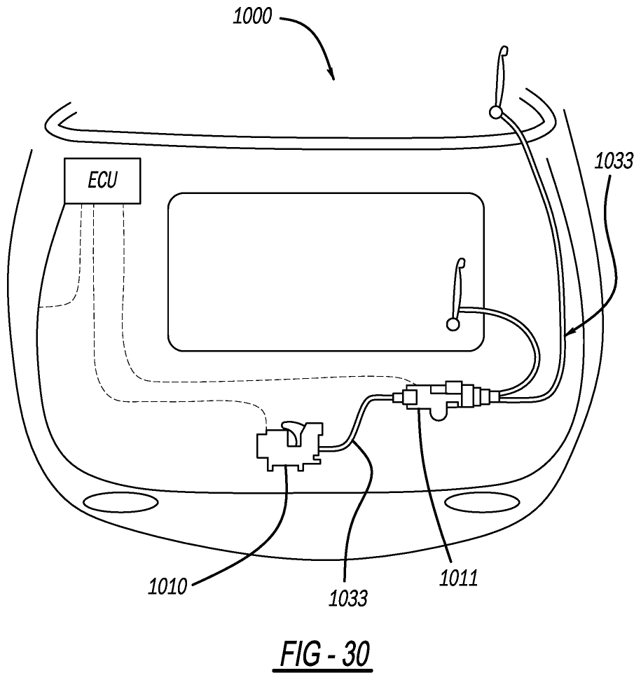

FIG. 30 illustrates yet another aspect of the disclosure, including a system 1000, including switch 1011 configured for actuation of latch 1010 via cable 1033. ECU is in communication with the switch 1011, which may be cable actuated from inside the vehicle as well from inside the frunk. Both first portions of the cable 1033 extending from each manual release lever extend into switch 1011.

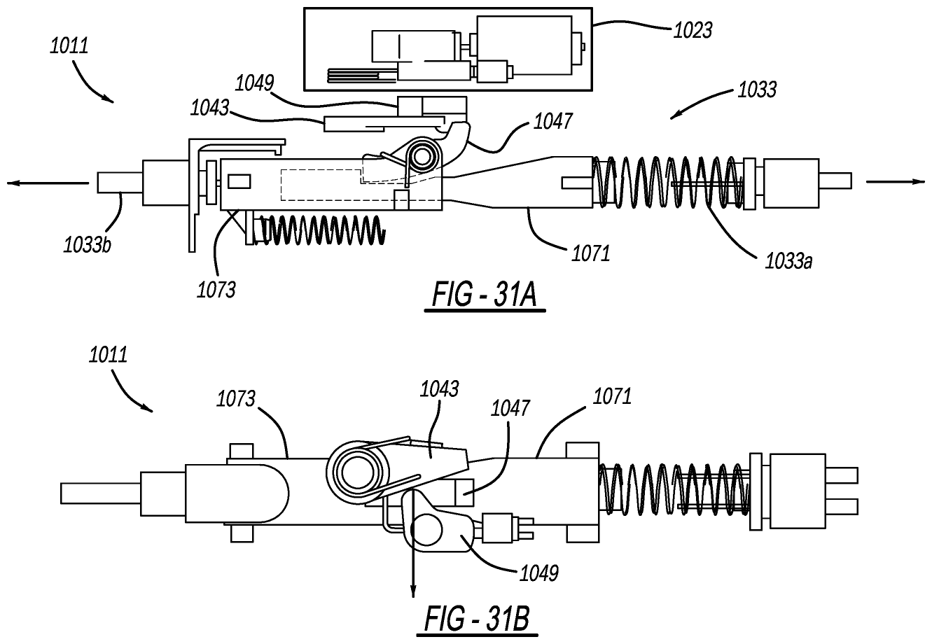

FIG. 31A-B provides further detail of switch 1011. Switch 1011 is coupled to motor 1023, which actuates gear output lever 1049 based on signals from the ECU regarding the vehicle speed. Pivoting of gear output lever 1049 allows pivoting movement of cam 1043. Cam 1043 moves into engagement with connecting lever 1047 (similar to how connecting hook 847 and 947 are moved in response to engagement with a cam), forcing connecting lever 1047 to pivot downward at its engagement with cam 1043, causing its opposite end to move upward. As shown, the gear output lever 1049 is in position and engaging cam 1043, and will slide/cam along the side surface of the cam 1043, allowing cam 1043 to pivot according to its bias. In this aspect, the cam 1043 is biased downward in FIG. 31B, and lever 1049 acts against the bias, and is actuatable to allow the cam 1043 to move. The force vector shown in FIG. 31B is shown off-center from the axis of both the lever 1049 and the cam 1047.

Switch 1011 includes slider 1071, which is fixed to first cable portion 1033a, and will be pulled in response to a pulling force on the cable 1033 (via manual release handle inside the vehicle or inside the frunk, and/or a release actuator). Slider 1071 is selectively coupled and decoupled for slidable movement relative to slider housing 1073. Slider 1071 remains received within slider housing 1073. Whether or not movement of the slider 1071 causes movement of the slider housing 1073 depends on the position of the connecting lever 1047. The connecting lever 1047 is pivotally coupled to the slider housing 1073, such as via a pin, and the connecting lever 1047 will be pulled by the slider 1071 in one state, but allow the slider to bypass the connecting lever 1047 in another state. When the connecting lever is pulled, the slider housing 1073 is pulled.

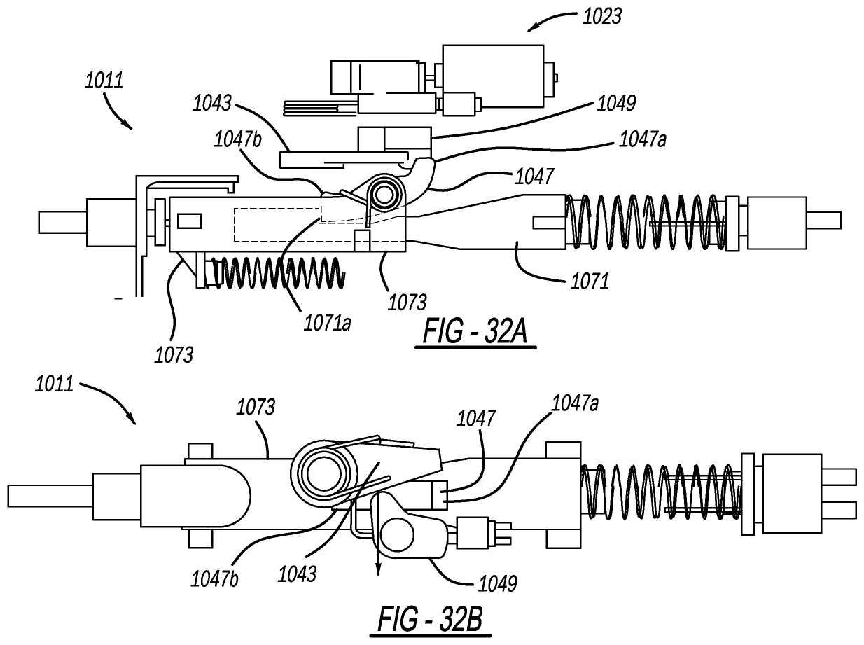

As shown in FIG. 32A-B, and mentioned above, the gear output lever 1049 is disposed eccentrically offset from the cam 1043, and the force vector F caused by contact between cam 1043 and output lever 1049 is eccentric and offset from the pivot axes of both the output lever 1049 and the cam 1043. The offset force vector F reduces the risk of unwanted lock by a higher spring force from the connecting lever 1047.

FIG. 32A-B illustrates a passageway state of the system 1000, where the vehicle is traveling below the threshold speed, and double pull full opening of the latch 1010 is permitted. As shown, the connecting lever 1047 is not engaged by the end of the cam 1043. The output lever 1049 is holding the cam 1043 away from the connecting lever 1047. The connecting lever 1047 has a first end 1047a and a second end 1047b. The first end 1047a extends upward and is disposed in the pivoting path of the cam 1043. The first end 1047a is biased upward and will be contacted by the cam 1043 to force the first end 1047a downward during a return movement following a first pull. Prior to the first pull, the cam 1043 will rest against the side of the connecting lever 1047.

The second end 1047b engages with a recess 1071a of the slider 1071, and extends downward into the slider 1071. When the slider 1071 is pulled and the second end 1047b is in its downward position, the connecting lever 1047 will be pulled along with the slider 1071. When the second end 1047b is raised out of the recess 1071a in response to the first end 1047a being forced downward by the cam 1043, pulling on the slider 1071 will not cause the connecting lever 1047 to be pulled, and the end of the recess 1071a will pass under connecting lever 1047.

The connecting lever 1047 is attached to the slider housing 1073. Thus, when the connecting lever 1047 is engaged with the slider 1071, movement of the slider 1071 in response to pulling force is transferred to the slider housing 1073 via the connecting lever 1047. Accordingly, the slider housing 1073 moves along with the slider 1071 in this state, and the second cable portion 1033b will be pulled and the latch 1010 will be actuated.

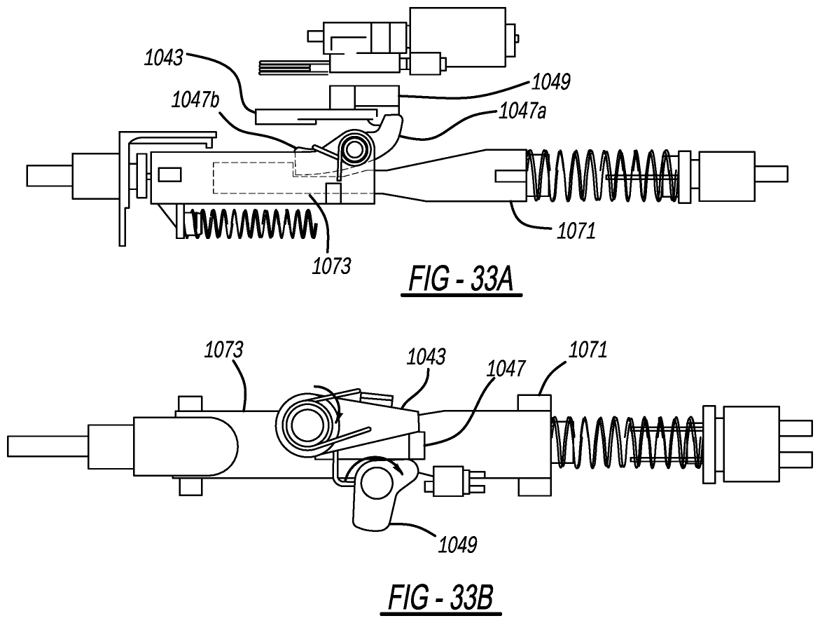

FIG. 33A-B illustrates a security state being signaled when the vehicle speed is above a threshold level, but before a first pull has occurred. The output lever 1049 is shown pivoted away from contact with the cam 1043 in response to actuation of the output lever 1049 by the motor 1023. The cam 1043 has pivoted into contact with the side of the first end 1047a of the coupling lever 1047. The coupling lever 1047 has not yet been moved out of engagement with the slider 1071, and the cam 1043 has not yet pushed the coupling lever 1047 down. In this state, the slider 1071 has a free stroke distance of 2 mm, meaning the slider 1071 could be actuated 2 mm prior to contacting the second end 1047b of the coupling lever 1047. which is still in the path of the slider 1071.

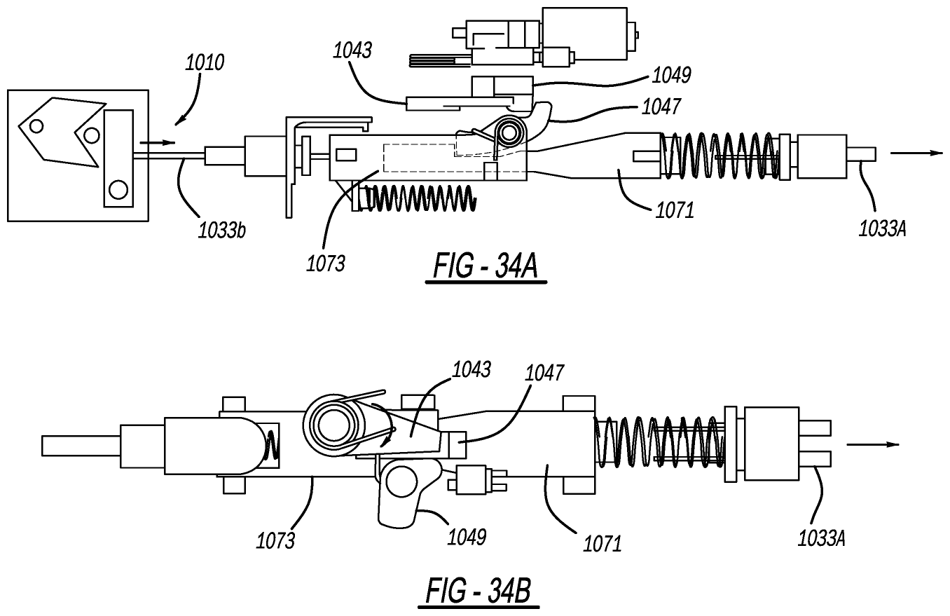

FIG. 34A-B illustrates a first pull of the slider 1071 in response to actuation of the first cable portion 1033a. The slider 1071 contacts coupling lever 1047 and pulls it to the right. A 6 mm pull causes a 4 mm actuation at the latch 1010 due to a 2 mm free stroke. The first end 1047a of coupling lever 1047 moves past the cam 1043 (compare position of lever 1047 in FIG. 34A to FIG. 33A), such that the cam 1043 can move further and align with the first end 1047a of the connecting lever 1047 (compare position of cam 1043 in FIG. 34B to 33B). In FIGS. 34A-B, the first pull has been completed, even with the gear output lever 1049 actuated due to the speed being above the threshold level. Thus, switch 1011 allows a first pull the safety state (in addition to allowing a first pull in the passageway state). The difference is in the actuation of the lever 1047 on the return movement following the first pull.

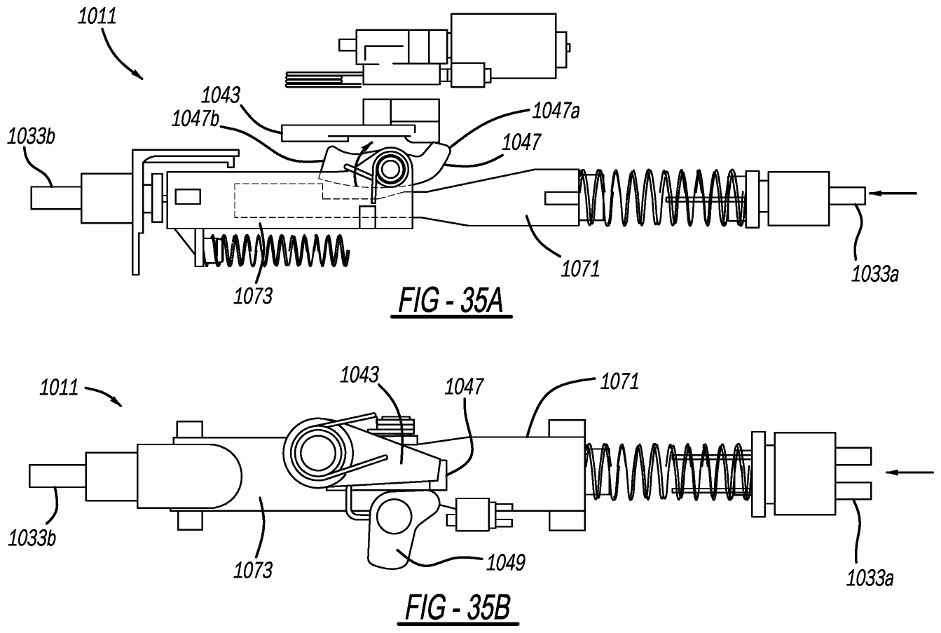

FIG. 35A-B illustrates the switch 1011 following the first pull, as the slider 1071 returns to the left. The cam 1043 is in line with the first end 1047a of the coupling lever 1047. As the first end 1047a comes into contact with the cam 1043, the first end 1047a is forced downward, thereby raising the second end 1047b out of the recess 1071a as the slider 1071 moves back to the left following the first pull. In this state, the slider 1071 becomes disengaged from the slider housing 1073, meaning that the slider 1071 can slide relative to the housing 1073 without causing the housing 1073 to move. When the housing 1073 does not move, the second cable portion 1033b is not pulled, even when the first cable portion 1033a is pulled. Following the first pull, the latch 1010 is in the secondary latched state, but not fully opened. Another pull of the slider 1071 in this state will not pass the pulling force onto the latch 1010.

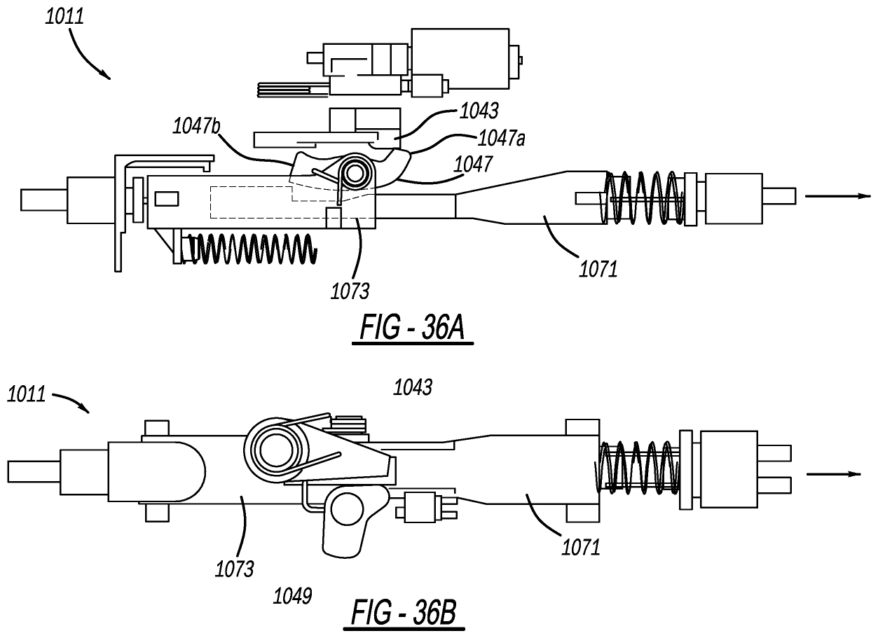

In the case of such a second pull, shown in FIG. 36A-B, such as from a manual actuation from inside the vehicle or inside the frunk, the slider 1071 is pulled to the right again. However, with the second end 1047b raised out of engagement with the slider 1071, the slider 1071 moves past the coupling lever 1047 without imparting a corresponding pulling force on the housing 1073.

When the safety state is ended, the motor 1023 can be reversed, which rotates the output lever 1049 back to the positon of FIG. 32A-B, which pushes the cam 1043 out of engagement with the coupling lever 1047. The coupling lever 1047 can therefore pivot back into engagement with the slider 1071 and into the recess 1071a, allowing a pulling force on the slider 1071 to be imparted on the housing and ultimately to the latch 1010.

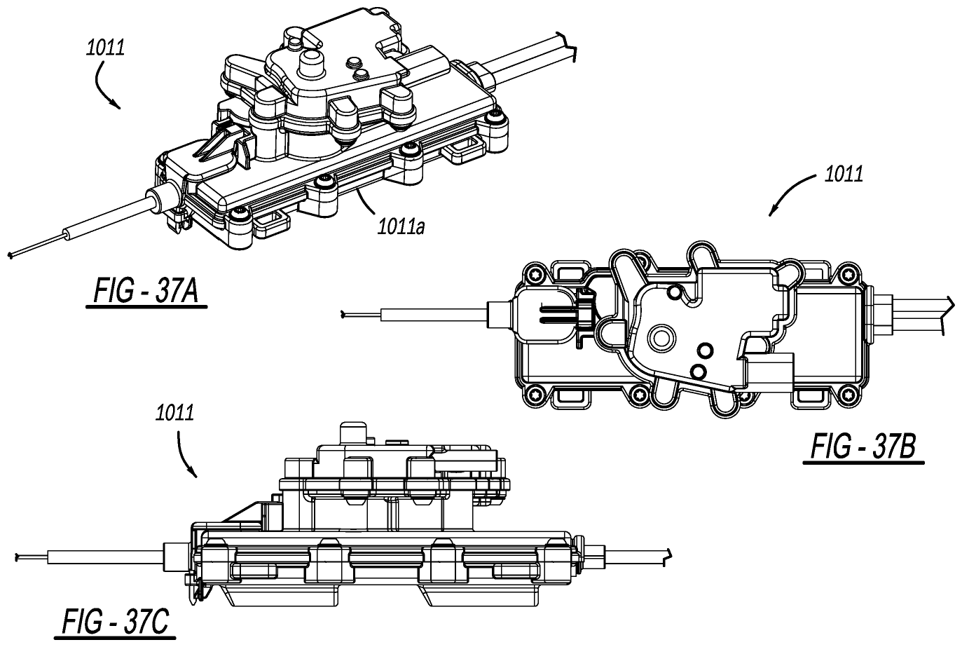

FIG. 37 illustrates a housing 1011a that houses the components of the switch 1011 and the motor 1023.

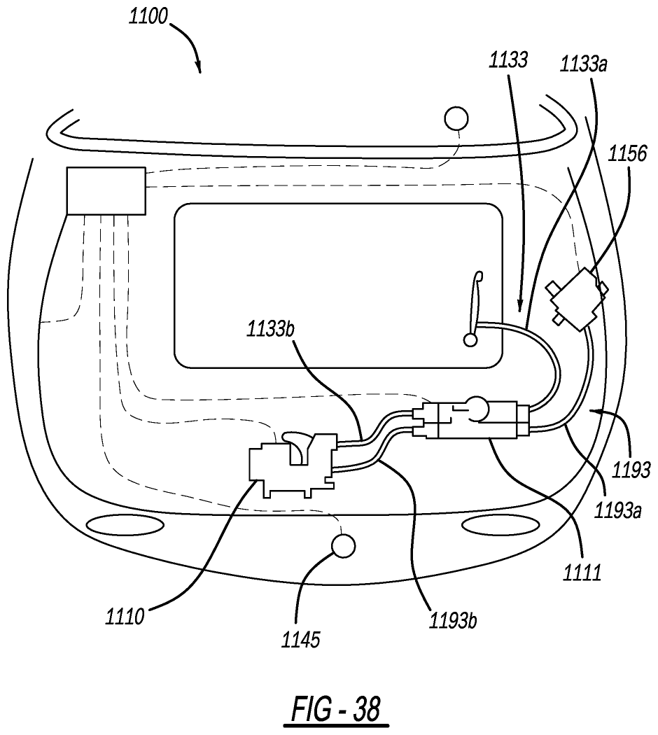

FIG. 38 illustrates another system 1100 according to another aspect of the disclosure. In this aspect, there is no manual release lever in the cabin. Release actuator 1156 is connected to ECU for actuating release actuator cable 1193 in response to an actuation signal initiated from within the passenger compartment or at a front sensor 1145. The system 1100 also permits manual release initiated from inside the frunk. Cable 1133 extends from the manual release actuator within the frunk into switch 1111. Accordingly, there are two first cable portions extending into the switch 1111 (one from the frunk and one from the actuator 1156).

Latch 1110 also includes a separate safety latch. The system 1100 includes two second cable portion 1133b, 1193b extending from the switch 1111 for actuating the latch 1100 via both the electric and manual release mechanisms. In short, the ECU can control whether a second pull is actuated based on the detected vehicle speed, and such actuation can bypass the switch 1100 via cable 1193. The manual release from inside the frunk, because it can be pulled by an operator more than once, may be subject to the coupling and decoupling of the cable 1133 via the switch 1111.

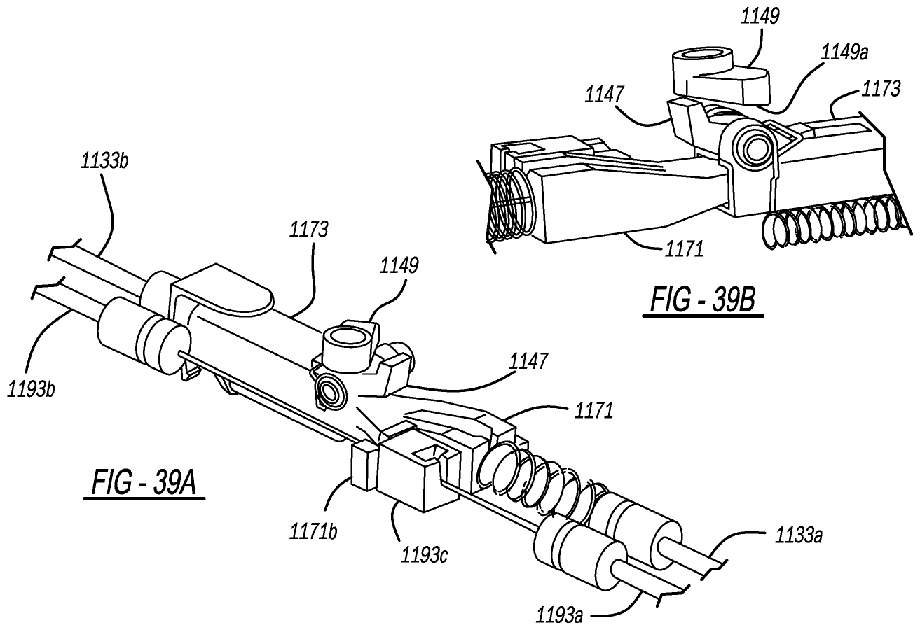

Switch 1111 is shown in further detail in FIG. 39A-B. As shown in FIG. 39A-B, the switch 1111 includes connecting lever 1147, and gear output lever 1149. Gear output lever 1149 operates to directly actuate connecting lever 1147. Gear output lever 1149 includes a cam surface 1149a, which engages the connecting lever 1147 when the gear output lever 1149 is actuated by the ECU. The first end 1147a is behind the gear output lever 1149, such that a first or second pull moves the connecting lever 1147 away from the gear output lever 1149 when the output lever 1149 is not actuated, allowing the pulling force to be transmitted to the latch 1110 via the slider housing 1073. When the lever 1149 is actuated, lever 1149 is pivoted out of engagement with the slider 1171, such that a pulling force on the slider 1171 is not transferred to slider housing 1173. The gear output lever 1149 performs a function similar to cam 1043 in system 1000 to selectively actuate the connecting lever 1147. In this aspect, however, because the switching function is applied to the manual lever inside the frunk, the connecting lever 1147 is pivoted out of the path of the slider regardless of whether a first pull has occurred. The decoupling of the manual lever will occur prior to a first pull, for example. If the decouple occurs due to a safety state, a first pull is transferred to the switch 1111 via cable 1193b rather than 1133b.

A pulling force on the slider 1171 is caused by a pulling force on the first cable portion 1133a that is attached to the frunk actuation lever (the manually actuated lever). A pulling force caused by the first cable portion 1193a connected to the ECU-controlled electric release actuator does not cause a pulling force on the slider 1171, as further described below. As shown, a pulling force from inside the frunk will cause the slider to be pulled, and therefore the second cable 1193 attached to the pawl of the latch 1110 will be pulled, regardless of the state of the connecting lever 1147. Accordingly, even if the speed exceeds the threshold level, a person in the frunk can actuate the pawl by actuating the first cable 1133a and the slider 1171, with the slider housing 1173 remaining stationary such that the safety catch remains in place to prevent the hood from fully opening.

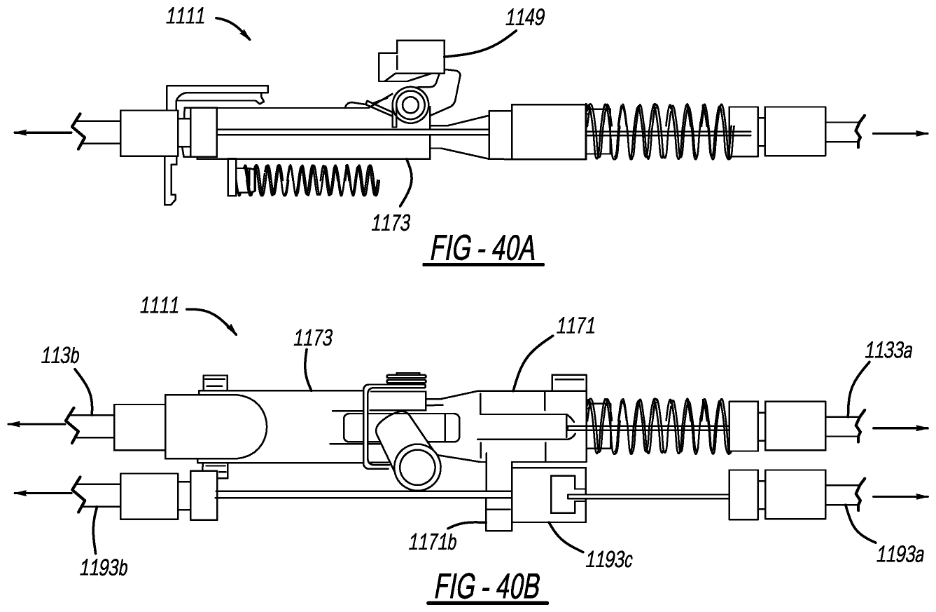

FIG. 40A-B illustrates a side view and a top view of the switch 1111 with the output lever 1149 not actuated (for instance when the speed is below a threshold level). The connecting lever 1147 is biased into engagement with slider 1171, such that pulling on the slider 1171 will pull on the connecting lever 1147, which pulls on the slider housing 1173 and the second cable portion 1133b attached thereto, which is attached to the separate safety hook of the latch 1110. A pulling force on the slider 1171 occurs in response to actuation inside the frunk. Such an actuation on the slider 1171 from the lever in the frunk will also actuate the second cable portion 1193b that extends to the pawl of the latch 1110. Thus, in the passageway state, below the threshold level, a pull from inside the frunk releases both the pawl and the safety catch via cables 1133b and 1193b.

The slider 1171 includes a laterally extending flange 1171b positioned behind a ferrule 1193c attached to second cable 1193. Thus, pulling on the slider 1171 also pulls on the second cable 1193 and actuates the pawl of the latch 1110, regardless of whether the slider housing 1173 is pulled. Thus, cable 1193 is actuated both by the electric release actuator 1156 and the manual release lever of the frunk.

FIG. 40A-B illustrates the output lever 1149 non-actuated. Pulling on first cable 1133 from inside the frunk will actuate the pawl via cable 1193 and will actuate the safety hook via slider 1171 and movement of the slider housing 1173 via the connection therebetween by connecting lever 1147.

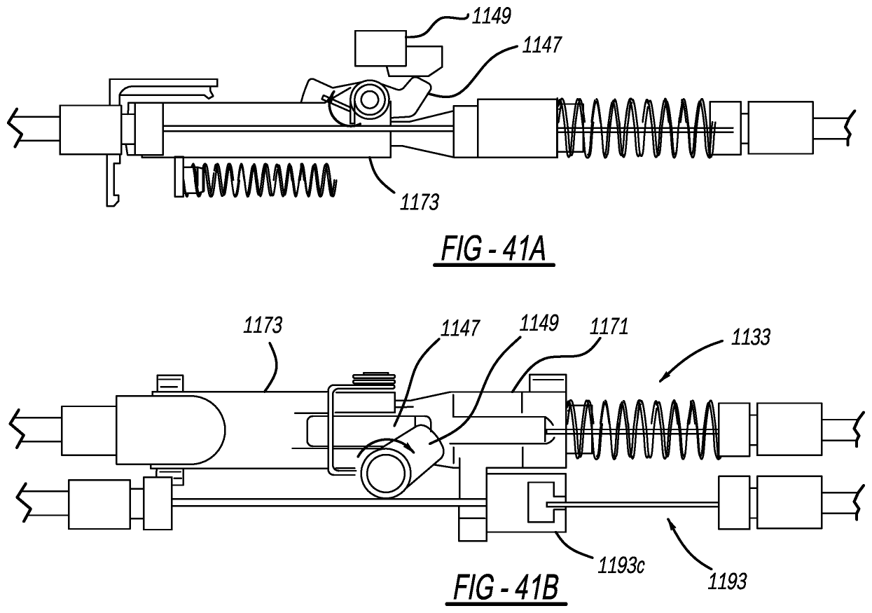

FIG. 41A-B illustrate the output lever 1149 actuated. Connecting lever 1147 is disengaged from the slider 1171 (regardless of a first pull) after being engaged by output lever 1149. A first pull from inside the frunk will pull on cable 1193 via ferrule 1193c and slider 1171, but slider housing 1173 will not be actuated and the safety hook will remain in place to block a full opening. Repeated pulling on cable 1133 or cable 1193 will continue to actuate cable 1193, but safety hook will not be pulled. Safety hook will be released after the output lever 1149 moves back to its disengaged position relative to the connecting lever 1147 (when vehicle speed is below threshold such as shown in FIG. 40), such that a pull on cable 1133 will be transmitted to slider housing 1173, which pulls on the end of the cable 1133 connected to the latch 1110.

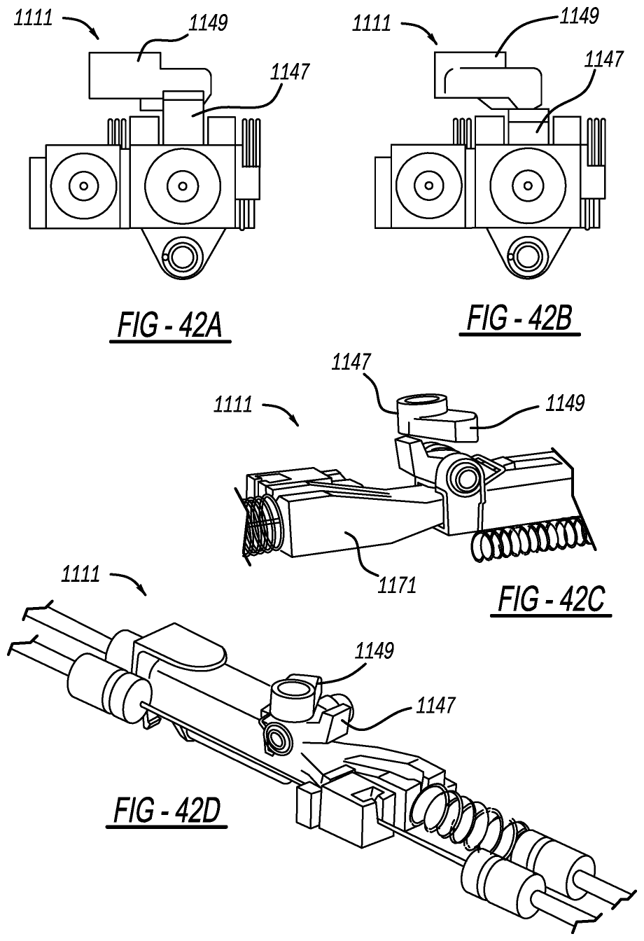

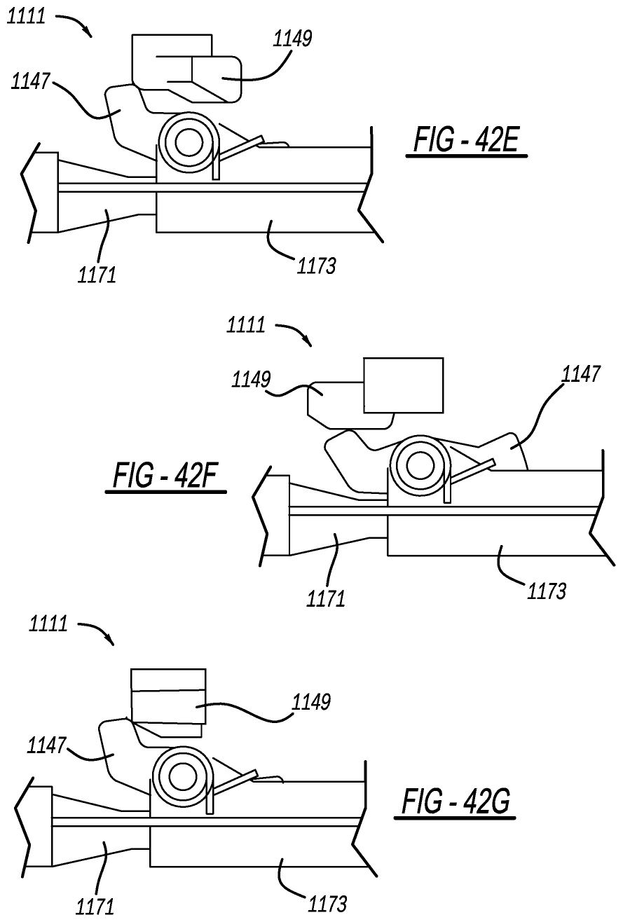

FIG. 42A-G provides multiple additional views of the switch 1111 and its various components in different states, in particular the output lever 1149 and connecting hook 1147. FIGS. 42A and 42E shows the output lever 1149 non-actuated and the connecting hook 1147 non-actuated. FIGS. 42B and 42F shows the lever 1149 actuated, and the hook 1147 actuated downward, and out of engagement with slider 1171. FIG. 42G illustrates the lever 1149 in an intermediate position, about to pivot the connecting hook 1147. FIGS. 42C-D illustrate perspective views of the lever 1149 not engaged with the hook 1147, and the slider 1171 received in the housing 1173. Connecting hook 1147 may also be referred to as connecting lever.

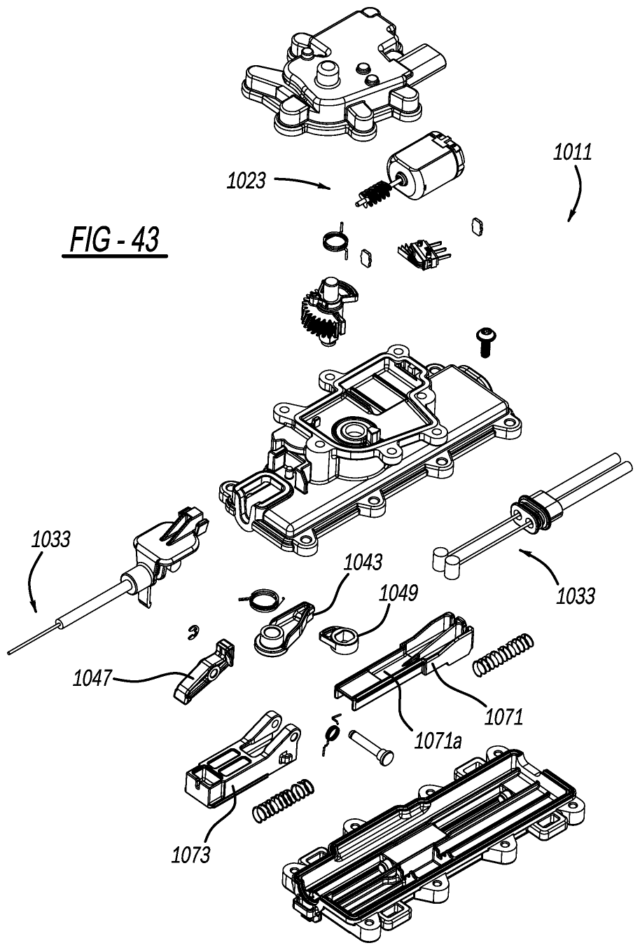

FIG. 43 is an exploded view of switch 1011 described above, and includes similar structure as switch 1111. The exploded view illustrates how slider housing is received in the housing of the switch 1011, the pivot pin connection of connecting hook 1047 relative to slider housing 1073. Recess 1071a of slider 1071 is also illustrated with additional clarity. These components are arranged similar to switch 1111, with the difference being the direct actuation of connecting hook 1147 without waiting for the first pull and return movement to pivot the connecting hook 1147. Of course, other aspects of switch 1111 are different relative to switch 1011, as is apparent from the other figures. It will be appreciated that other slider and housing shapes, or hook shapes, may be used while providing the same functional described and illustrated herein. Connecting hook 1047 may also be referred to as connecting lever.

Thus, in view of each of the above-described aspects of the disclosure, double pull actuation of a double pull latch can be blocked or otherwise prevented by occurring by actuating members of the latch itself, or by blocking/disengaging the actuation cable leading to the double pull latch. The various versions of the switches described herein can be used in various control schemes for blocking/disengaging the actuating cable that extends to the double pull latch. As is apparent from the above, reference to double-pull may refer to both sequential pulls or dual-pulls for actuating a pawl and/or safety hook of a hood/frunk latch.

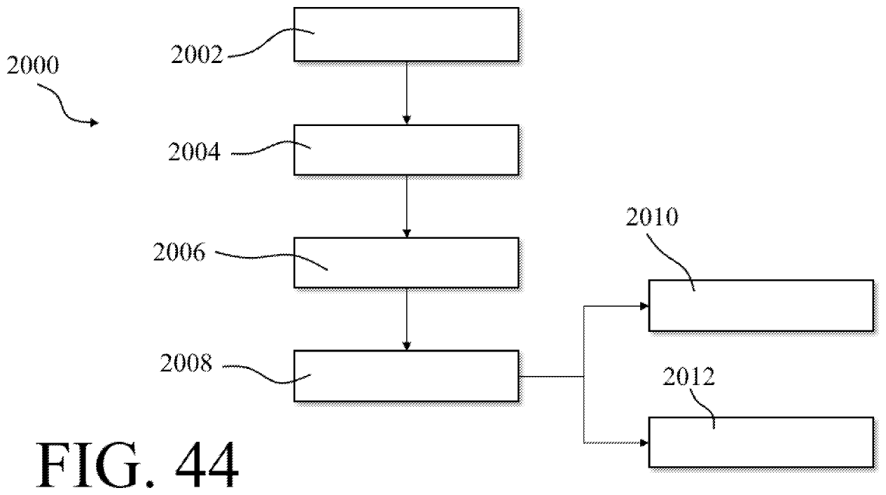

Now additionally referring to FIG. 44, there is shown an example method 2000 for controlling a coupling assembly for a latch, such as a double pull latch as described herein. The method 2000 includes the step of ascertaining the state of a vehicle 2002, which may include determining or receiving speed information, signals, or data of the vehicle from a sensor or a vehicle controller. Then the method 2000 next includes the step of ascertaining a first activation of the latch 2004, which may include determining if an actuation of a release mechanism has occurred for a first time, such as if a first pull of a handle release mechanism has occurred by determining or receiving switch information, signals, or data, associated with the activation of the release mechanism. Then the method 2000 next includes in step 2006, controlling a state of a coupling assembly positioned between the latch and the release mechanism of operatively coupling/decoupling the latch with the release mechanism, in response to actuation of the release mechanism occurring for the first time and based on the state of a vehicle 2008, which may include controlling a motor of the coupling assembly to change the state of the coupling assembly between a safety mode and a normal mode, where such modes are illustratively described in more details herein above. Requiring as a condition for changing the state of the coupling assembly to have as a prerequisite an activation of the handle release mechanism before changing the state of the coupling assembly avoids change the state of the coupling assembly every time the vehicle state changes, such as when the state of the vehicle is speed transitioning from a speed below or above a speed threshold. Such exemplary speed transitions occur frequently during a vehicle operation which consequentially may lead to change the state of the coupling assembly frequently and unnecessarily, leading to an over use of a motor of the coupling assembly and/or operation of other component for example. Then the method 2000 next includes in step 2010, controlling the state of the coupling assembly in the normal mode to configure the coupling assembly to facilitate transfer of a second pull of the handle release mechanism to allow the latch to be fully opened. Or in step 2012, the method 2000 next includes controlling the state of the coupling assembly in the safety mode to configure the coupling assembly to inhibit the transfer of the second pull of a handle release mechanism to the latch to prevent the latch from being fully opened.

It will be appreciated that various vehicle sensors and control modules may be used to detect the various states and provide the various signals or commands referred to herein.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latching system for a hood or a trunk of a vehicle, the system comprising:
a latch;
a release mechanism configured to be accessible within the trunk or the cabin of the vehicle for actuating the latch;
a coupling assembly positioned between the latch and the release mechanism;
wherein actuation of the release mechanism when the coupling assembly is in a normal mode causes the latch to release;
wherein actuation of the release mechanism when the coupling assembly is in a safety mode prevents the latch from releasing.

2. The system of claim 1, wherein the latch is a double-pull latch, wherein a first pull applied to the latch moves the latch from a primary latched state to a secondary latched state, and a second pull applied to the latch moves the latch from the secondary latched state to a fully open state, and the coupling assembly is a switch configured to selectively prevent a second pull from being applied to the latch.

3. The system of claim 2, wherein the switch prevents a second pull from being applied to the latch in response to a predetermined condition of the vehicle being satisfied.

4. The system of claim 3, wherein the predetermined condition is a threshold speed being exceeded.

5. The system of claim 3, wherein the switch blocks an actuation cable from being pulled or the switch is disposed between a first portion of a cable and a second portion of a cable, wherein the switch disengages the first portion from the second portion.

6. The system of claim 3, wherein the predetermined condition includes a first pull being completed and a threshold speed being exceeded.

7. The system of claim 3, wherein the switch includes a connecting lever pivotable between an engaged position coupling a first cable portion and a second cable portion, and a disengaged position in which the first cable portion and the second cable portion are de-coupled.

8. The system of claim 7, wherein the connecting lever moves from the engaged positon to the disengaged position in response to engagement by a cam.

9. The system of claim 7, wherein the connecting lever moves from the engaged position to the disengaged position in response to engagement by a cam and following a first pull when in the engaged position.

10. A latching system for a hood or a trunk of a vehicle, the system comprising:
a latch (510, 1010, 1110);
a release mechanism (535) configured to be accessible within the trunk or the cabin of the vehicle for actuating the latch;
a switch (511, 1011, 1111) positioned between the latch and the release mechanism;
wherein actuation of the release mechanism (535) when the switch is in a normal mode causes the latch to release;
wherein actuation of the release mechanism (535) when the switch (511, 1011, 1111) is in a safety mode prevents the latch (510, 810, 910, 1010, 1110) from releasing;
wherein the switch (1011, 111) includes a slider (1071, 1171) attached to a first cable portion (1033a, 1133a) and a slider housing (1073, 1173) attached to a second cable portion (1033b, 1133b), wherein the switch (1011, 111) is actuatable between an engaged state coupling the slider (1071, 1171) to the slider housing (1073, 1173) and a disengaged state in which the slider (1071, 1171) is de-coupled from the slider housing (1073, 1173), wherein translation of the slider (1071, 1171) in the engaged state translates the slider housing (1073, 1173), and translation of the slider (1071, 1171) in the disengaged state does not translate the slider housing (1073, 1173).

11. The system of claim 10, wherein the switch includes a connecting lever pivotally attached to the slider housing, wherein the connecting lever is selectively moveable into and out of engagement with the slider.

12. The system of claim 11, wherein a cam is actuatable into engagement with the connecting lever to actuate the connecting lever out of engagement with the slider.

13. The system of claim 12, wherein the cam actuates the connecting lever only after the slider has been pulled a first time.

14. The system of claim 12, wherein the cam is actuated into an intermediate position in response to actuation by a gear output lever.

15. The system of claim 14, wherein the cam is biased toward engagement with the connecting lever, and the gear output lever is actuated to pivot away from the cam and allows the cam to move toward engagement with the connecting lever.

16. The system of claim 15, wherein a force vector applied by the cam on the gear output lever prior to actuation by the gear output lever is eccentric relative to pivot axes of the cam and the gear output lever.

17. The system of claim 13, wherein a first cable extends from a manual release lever and a second cable extends from an electric cable actuator, wherein the first cable is attached to the slider, and the second cable extends through the slider, wherein the slider housing is coupled to a safety hook of the latch, and the second cable is attached to a pawl of the latch.

18. The system of claim 17, wherein actuation of the first cable pulls the slider, and the slider pulls the second cable, and wherein actuation of the second cable independent of the first cable does not pull the slider, and actuation of the second cable occurs in response to a pull on the first cable in both the engaged and disengaged state of the connecting lever.

19. The system of claim 18, wherein the slider includes an outwardly extending flange, and the second cable includes a ferrule fixed thereto, wherein the flange applies a force on the ferrule in response to a pulling force applied to the slider.

20. A method of operating a latch for a trunk or a hood of a vehicle, the method comprising:
detecting a condition that satisfies a predetermined condition of the vehicle;
in response to detecting the predetermined condition, actuating a switch from a normal mode to a safety mode;
wherein the switch is positioned between a latch and a release mechanism, wherein the release mechanism is accessible within the trunk or the cabin of the vehicle and configured for actuating the latch;
wherein actuation of the release mechanism when the coupling assembly is in a normal mode causes the latch to release;
wherein actuation of the release mechanism when the coupling assembly is in a safety mode prevents the latch from releasing;
permitting a first actuation of the latch via the switch when the switch is in the normal mode or the safety mode;
preventing a second actuation of the latch via the switch when the switch is in the safety mode; and
permitting the second actuation of the latch via the switch when the switch is in the normal mode.
